(19) United States
(12) Patent Application Publication
(10) Pub. No.: US 2024/0386489 A1
(43) Pub. Date: Nov. 21, 2024

(54) TOKENIZED ASSET EXCHANGE

(71) Applicant: Wells Fargo Bank, N.A., San Francisco, CA (US)

(72) Inventors: Nathaniel C. Eutsler, San Francisco, CA (US); Muthoni Kiarie, San Francisco, CA (US); Patrick William Leary, San Francisco, CA (US); Arushi Sood Joshi, San Francisco, CA (US)

(73) Assignee: Wells Fargo Bank, N.A., San Francisco, CA (US)

(21) Appl. No.: 18/198,125

(22) Filed: May 16, 2023

(51) Int. Cl. G06Q 40/03; G06Q 20/36; G06Q 20/38

(52) U.S. Cl. CPC G06Q 40/03; G06Q 20/36; G06Q 20/381

(57) ABSTRACT

Some arrangements relate to a system that includes a data processing system including memory and one or more processors to receive, from a first computing system, a commitment request corresponding to first funds, in response to receiving the commitment request, generate first tokens by tokenizing the first funds, transmit the first tokens into a first digital wallet, generate share tokens based on a number of shares corresponding to the first funds, transmit the share tokens to a second digital wallet associated with the first computing system, determines return based on a quantity of the share tokens, convert, based on the return, second tokens to second funds, where converting includes burning the second tokens by transmitting the second tokens to an un-spendable address, and retrieving the second funds from a return funds account. The one or more processors further transmit the second funds to a first funds account.

### TECHNICAL FIELD

The present implementations relate generally to assets, and more particularly to digital asset exchange.

### INTRODUCTION

The present disclosure relates generally to assets, and more particularly to digital asset exchange protection. In a computer networked environment such as the internet, users and entities, such as people, organizations, or companies, may exchange digital assets.

### SUMMARY

Some arrangements relate to a system that includes a data processing system including memory and one or more processors to receive, from a first computing system, a commitment request corresponding to first funds and, in response to receiving the commitment request, generate first tokens by tokenizing the first funds. The one or more processors further transmit the first tokens into a first digital wallet, generate share tokens based on a number of shares corresponding to the first funds, transmit the share tokens to a second digital wallet associated with the first computing system, determine return based on a quantity of the share tokens, and convert, based on the return, second tokens to second funds. Converting includes burning the second tokens by transmitting the second tokens to an un-spendable address, and retrieving the second funds from a return funds account. The one or more processors further transmit the second funds to a first funds account.

Some arrangements relate to a system that includes a data processing system including memory and one or more processors to receive, from a first computing system, a commitment request corresponding to first funds and an agreement, and, in response to receiving the commitment request, generate first tokens by tokenizing the first funds and generate an agreement token by tokenizing the agreement. The one or more processors further transmit the first tokens to a first digital wallet, and transmit the agreement token to a second digital wallet associated with the first computing system.

Some arrangements relate to a system that includes a data processing system including memory and one or more processors to receive a commitment request corresponding to an agreement, and, in response to receiving the commitment request, generate an agreement metadata object including metadata of the agreement and one or more transferring attributes for transferring first funds associated with the agreement from a user funds account to an entity funds account. The one or more processors further generate, based on the agreement metadata object, an agreement token including a link to the agreement metadata object and encapsulated within a control structure that restricts transfer of the first funds from the user funds account into the entity funds account. The one or more processors further continuously monitor the agreement based on collecting off-chain data from one or more off-chain data feeds, and detect, by the control structure, at least one transferring attribute of the one or more transferring attributes is satisfied based on the off-chain data. The one or more processors further, in response to detecting the at least one transferring attribute is satisfied, transfer the first funds from the user funds account into the entity funds account, in response to transferring the first funds, generate first tokens by tokenizing the first funds, and transmit the first tokens into a first digital wallet.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 depicts an example system, in accordance with present implementations.

FIG. 2 depicts an example protection architecture, in accordance with present implementations.

FIG. 3 depicts an example protection architecture, in accordance with present implementations.

FIG. 4 depicts an example transaction processor, in accordance with present implementations.

FIG. 5 depicts a method to facilitate asset exchanges utilizing tokens, in accordance with present implementations.

FIG. 6 depicts another method to facilitate asset exchanges utilizing tokens, in accordance with present implementations.

FIG. 7 depicts yet another method to facilitate asset exchanges utilizing tokens, in accordance with present implementations.

FIG. 8 depicts a ledger and a blockchain storage within the data processing system of FIG. 1, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

This technical solution can include a smart contract control structure that encapsulates a token. The smart contract control structure can allow output of various contents linked to the token upon determining at least one attribute (e.g., transferring attribute, outputting attribute, etc.) of a plurality of attributes is satisfied. For example, the smart contract control structure, and the token within the smart contract control structure, can be rendered unusable outside the particular computing environment. This technical solution can include multiple layers of secure access control to tokens, including authorization control at a smart contract layer by one or more tokens, and authorization control at a container layer by a private key. The private key can be based on one or more tokens, and can be fully contained within a single token or partially contained within multiple tokens. This technical solution can include generation of smart contract control structures and modification of blockchain architecture to restrict the tokens. A smart contract can, for example, generate or modify a smart contract to contain one or more tokens. The generator smart contract can search a blockchain to identify tokens satisfying particular attributes or parameters. The attributes can be transmitted to the generated smart contract by a token. The generated smart contract can generate a token that can include a non-fungible token (NFT), a semi-fungible token, or a fungible token, and can distribute that token while retaining locally the smart contract control structure and its restricted tokens.

The systems described herein provide improvements over typical asset exchange systems and data storage/access system. That is, the technical problem that arises from typical exchange systems and data systems occurs when assets and data of the assets are stored and transferred with minimal security or authorization checks. Thus, to improve asset protection and data securitization, a technical solution is accomplished by obfuscating and protecting the assets (e.g., digital or virtual) utilizing a token that is restricted by utilizing one or more particular control structures. This not only protects assets from hackers (or competitors) by reducing or eliminating the exposure or potential for manipulation of protected or private information of assets, but also protects entities and users from exposing their protected or private information, which is a significant improvement to the security and integrity of assets and data that are exchanged. Furthermore, the system described herein may provide an improvement over typical asset exchange systems and data storage/access system through the process of tokenizing funds. The tokenized fund may provide the advantage of being able to transfer funds, more particularly representation of funds (e.g., the tokens, etc.), in short amounts of time, or real-time, removing the need of long processing time associated with transfer of funds between funds accounts (e.g., cash accounts, etc.).

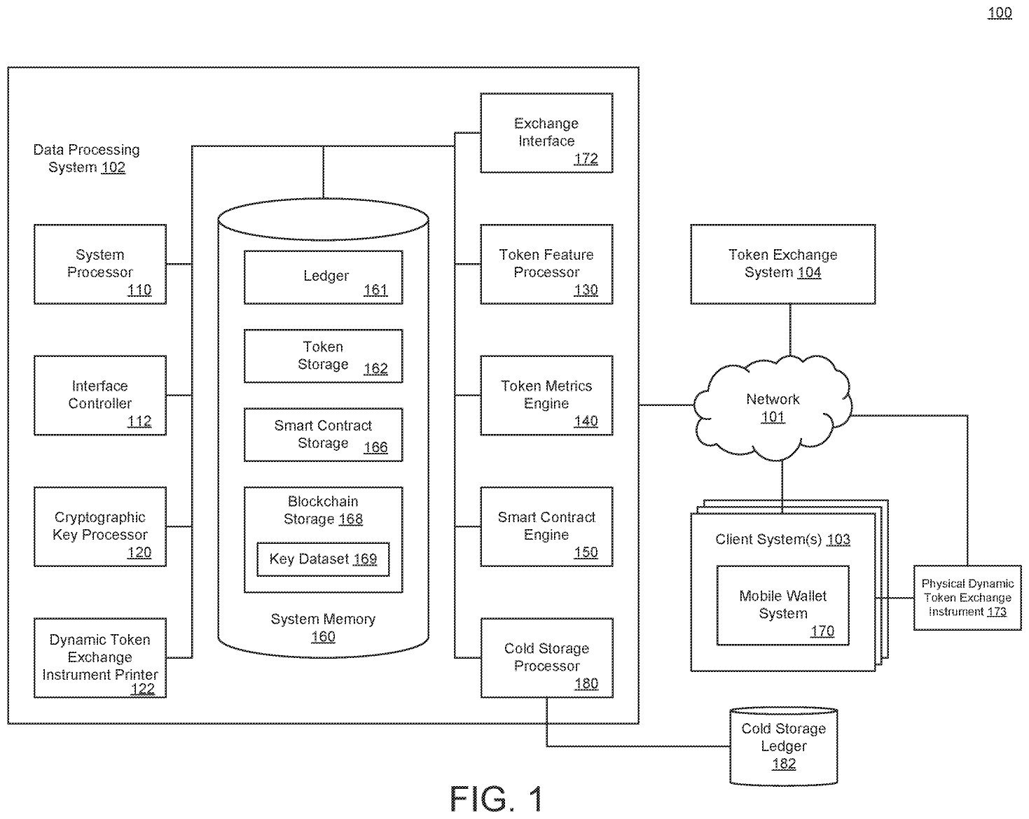

FIG. 1 depicts an example system, in accordance with present implementations. As illustrated by way of example in FIG. 1, an example system 100 can include at least a network 101, a data processing system 102, a client system 103, and a token exchange system 104.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include a network which is virtual and sits on top of one or more layers of other networks 101. The network 101 can include any such network topology as known to those ordinarily skilled in the art capable of supporting the operations described herein. The network 101 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 101 can include a type of a broadcast network, a telecommunications network, a data communication network, or a computer network.

The data processing system 102 can include a physical computer system operatively coupled or that can be coupled with one or more components of the system 100, either directly or through an intermediate computing device or system. The data processing system 102 can include a virtual computing system, an operating system, and a communication bus to effect communication and processing. The data processing system 102 can include a system processor 110, an interface controller 112, a cryptographic key processor 120, a token feature processor 130, a token metrics engine 140, a smart contract engine 150, a system memory 160, an exchange interface 172, and a cold storage processor 180.

The system processor 110 can execute one or more instructions associated with the system 100. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the system 100 generally can include one or more communication bus controller to effect communication between the system processor 110 and the other elements of the system 100.

The interface controller 112 can link the data processing system 102 with one or more of the network 101, the client system 103, and the token exchange system 104, by one or more communication interfaces. A communication interface can include, for example, an application programming interface (“API”) compatible with a particular component of the data processing system 102, the client system 103, or the token exchange system 104. The communication interface can provide a particular communication protocol compatible with a particular component of the data processing system 102 and a particular component of the client system 103 or the token exchange system 104. The interface controller 112 can be compatible with particular metadata objects, and can be compatible with particular metadata delivery systems corresponding to particular metadata objects. For example, the interface controller 112 can be compatible with transmission of video content, audio content, or any combination thereof. For example, the interface controller 112 can be compatible with payment processing transmissions by a protocol compatible with payment processing latency and encryption structures.

The cryptographic key processor 120 can generate and modify cryptographic keys. For example, the cryptographic key processor 120 can include one or more asymmetric or symmetric key generators, and can generate public-private key pairs. For example, a public-private key pair can include a public key configured to encrypt in accordance with a particular transform process. For example, a public-private key pair can include a private key configured to decrypt in accordance with a particular transform process compatible with the public key. In some arrangements, the cryptographic key processor 120 can link the public-private key pair with any individual object or component. In some arrangements, the cryptographic key processor 120 can link any public key or private key corresponding to the public-private key pair with any individual object or component. For example, the cryptographic key processor 120 can generate a key compatible with or linked with a particular identifier corresponding to a particular, device, user, customer, account, system, or any combination thereof.

The token feature processor 130 may identify one or more characteristics (sometimes referred to as “attributes” or “rules”) of one or more tokens. For example, the token feature processor 130 may identify one or more characteristics of an individual token or a plurality of tokens satisfying one or more criteria. The token feature processor 130 can generate a particular feature corresponding to one or more characteristics of a token or an object linked with the token. For example, a feature can include a scalar or vector quantity corresponding to one or more values of an aspect of a token. A feature can include a list of coordinates corresponding to a line identified in an image linked with a token. A feature can include a numeric value corresponding to an identifier of a token. In some examples, criteria by which tokens can be identified can include aspects of the token, fields or components of the token, transform processes used to generate or modify the token, aspects of a metadata object linked with the token, or any combination thereof. For example, aspects of the token can include a hash of the token, or a value of an individual field of the token. Aspects of a metadata object linked with the token can include a bitmap of an image linked with the token, or a hash of a media metadata linked with the token. Media metadata can include images, audio, three-dimensional (3D) models, or any combination thereof. In some arrangements, the token may be a fungible token or a non-fungible token (NFT).

The token metrics engine 140 can generate and modify one or more metrics based on one or more tokens. For example, the token metrics engine 140 can generate a metric based one or more features obtained from the token feature processor 130. The token metrics engine 140 can generate a metric to indicate a particular value or type of a particular token. The token metrics engine 140 can generate metrics compatible with particular thresholds. For example, the thresholds can activate particular transforms of an aspect of a token, feature, or metric. The thresholds can execute one or more instructions corresponding to a particular token or type of token, type of object linked a token, or any combination thereof. For example, the token metrics engine 140 can determine that a particular metric having a particular value and based on a type of a token satisfies a threshold that indicates a particular value compatible with the particular value of the metric.

The smart contract engine 150 (e.g., smart contract processing circuit, etc.) can generate and modify one or more smart contracts. The smart contract engine 150 can execute instructions to generate or modify a cryptographic container, to add or remove objects from a cryptographic container, and to execute various processors linked with or embedded with a smart contract. For example, the smart contract engine 150 can execute various processors of a smart contract in response to an indication from the token metrics engine 140 that a metric satisfies a particular threshold. For example, the smart contract engine 150 can execute various processors of a smart contract in response to detecting input including or corresponding to a particular token at the smart contract. For example, the smart contract engine 150 can include processors to read, write, generate, or modify one or more objects contained within a container of the smart contract, one or more tokens input to the smart contract, or one or more processors of the smart contract.

Additionally, the smart contract engine 150 can validate one or more tokens against one or more smart contracts. For example, the smart contract engine 150 can obtain one or more tokens, and can compare the one or more tokens to one or more tokens requested by a particular smart contract. The smart contract engine 150 can detect whether a particular token is compatible with a particular smart contract by detecting whether the particular token matches a particular token characteristic associated with the particular smart contract. For example, the smart contract engine 150 can detect that a token is compatible with a smart contract based on comparing a hash of the token with a hash included in the smart contract. The smart contract engine 150 can generate an authorization indication based on one or more determinations, and can transmit the authorization indication to the system processor 110. The smart contract engine 150 can, for example, provide a control structure or one or more metadata objects to the system processor 110, in response to the authorization indication, by decrypting the encapsulation layer of the control structure. The smart contract engine 150 can, for example, execute the smart contract with the compatible tokens to retrieve a particular control structure for the smart contract, or a reference to the particular control structure, from a storage device (e.g., a smart contract storage, the system memory 160, etc.).

The exchange interface 172 can communicate with one or more external systems compatible with transferring a token. For example, the exchange interface 172 can include an application programming interface (API) compatible with the token exchange system 104 and the client system 103. For example, the exchange interface 172 can be configured to receive characteristics associated with particular tokens, types of tokens, or metadata objects linked with the particular tokens. In some arrangements, the exchange interface 172 can be configured to receive particular quantitative values corresponding to particular transfer of tokens between accounts. The exchange interface 172 can thus provide the technical improvement of protecting tokens generated or received in response to transfer of a token between storage locations or blockchain locations. The exchange interface 172 can provide the technical improvement of providing a communication interface compatible with particular token transfer operations.

The system memory 160 can store data associated with the system 100. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, and a NAND memory device. The system memory 160 can include one or more addressable memory regions disposed on one or more physical memory arrays. A physical memory array can include a NAND gate array disposed on, for example, at least one of a particular semiconductor device, integrated circuit device, or printed circuit board device. The system memory 160 can include a ledger 161, a token storage 162, a smart contract storage 166, and a blockchain storage 168 including a key dataset 169.

The token storage 162 can store one or more tokens and corresponding addresses for particular tokens that indicate links with the corresponding tokens. The token storage 162 can include tokens associated with the data processing system 102 or any component thereof, the client system 103 or any component thereof, any metadata object, or any combination thereof. In some arrangements, the token storage 162 can store one or more fungible tokens, semi-fungible tokens, and/or non-fungible tokens. The token storage 162 can store corresponding addresses for particular fungible tokens that indicate links with the corresponding fungible tokens, corresponding addresses for particular semi-fungible tokens that indicate links with the corresponding semi-fungible tokens, and/or corresponding addresses for particular non-fungible tokens that indicate links with the corresponding non-fungible tokens.

The smart contract storage 166 can store one or more smart contracts and corresponding addresses for particular smart contracts that indicate links with the corresponding smart contracts. The smart contract storage 166 can also store one or more control structures and their contained metadata objects and corresponding addresses for particular control structures that indicate links with the corresponding control structures.

The blockchain storage 168 can store one or more blockchains linked to one or more smart contracts, tokens, control structures, or metadata objects, by corresponding addresses for particular smart contracts, tokens, control structures, or metadata objects that indicate links with a particular blockchain.

The key dataset 169 can store cryptographic keys associated with the data processing system 102 or any component thereof, the client system 103 or any component thereof, any metadata object, or any combination thereof. For example, the key dataset 169 can include public-private key pairs or private keys corresponding to particular accounts, tokens, smart contracts, devices, users, systems, or any combination thereof.

The client system 103 can include a computing system located remotely from the data processing system 102. The client system 103 can include a mobile wallet system 170. The mobile wallet system 170 can include an interface to execute instructions corresponding to a particular wallet account, and to modify the structure or contents of a particular smart contract corresponding to a wallet account. For example, the mobile wallet system 170 can include a user interface to receive input indicating selections of various tokens, transactions, accounts, devices, users, or systems. The user interface can include a graphical user interface that can be presented at a display device. The display device can display at least one or more user interface presentations, and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The mobile wallet system 170 can transmit one or more instructions, tokens, keys, or any combination thereof to, from, or with the data processing system 102.

The client system 103 may be used by a third party with a relationship to the token exchange system 104 or data processing system 102 (e.g., vendor, customer, entity, supplier, and so on) to perform various actions and/or access various types of data, some of which may be provided over network 101. The term “client” as used herein may refer to one or more individuals operating the one or more client systems 103 and interacting with resources or data via the client systems 103. The one or more individuals operating the one or more client systems 103 may of the same party (e.g., entity, institution, etc.) or of different parties. The client system 103 may be used to electronically transmit data (e.g., exchange requests, attributes, tokens) to the data processing system 102, to access websites (e.g., using a browser), to access the internet (e.g., using a mobile application, such as a decentralized application (dApp)), and/or to receive and/or transmit any other types of data.

The client system 103 (e.g., computing system, device, etc.) may be a mobile computing device, desktop computer, smartphone, tablet, smart watch, smart sensor, or any other device configured to facilitate receiving, displaying, and interacting with content (e.g., web pages, mobile applications, such as decentralized application (dApp), etc.). The client system 103 may include an input/output circuit for communicating data over the network 101 to the data processing system 102 and/or the token exchange system 104. In some arrangements, each of the client systems 103 can have a digital wallet address for exchanging (e.g., receiving or sending) fungible or non-fungible values (e.g., cryptocurrency, digital currency, stocks, bonds, loan, deed, etc.).

The token exchange system 104 can transfer one or more tokens between one or more smart contracts, blockchains, systems, wallet accounts, or any combination thereof, or the like. For example, the token exchange system 104 can include an exchange network to identify particular tokens and transfer the particular tokens between particular wallet accounts or systems. The token exchange system 104 can receive an instruction to transfer a token from a first account to a second account. In some examples, the instruction to transfer the token can be linked with a quantitative value indicating a value of the token. For example, the quantitative value can correspond to a value of fiat currency, math-based currency (MBC), or any combination thereof. MBC can include cryptocurrency or the like. The token exchange system 104 can detect characteristics associated with particular tokens, types of tokens, or metadata objects linked with the particular tokens, and can detect particular quantitative values corresponding to particular transfer of tokens between accounts.

Still referring to FIG. 1, in some arrangements, upon receiving a token, the cryptographic key processor 120 can identify public keys and private keys associated with the token. Upon identifying one or more private keys of the token, the cryptographic key processor 120 can verify the token using the one or more identified private keys. In some arrangements, the token may have been previously stored on the data processing system 102 and the public-private key pairs may be stored throughout the data processing system 102 (e.g., in the blockchain storage 168, a cold storage ledger 182, etc.). In some arrangements, the received token may be an external token stored on a storage medium or a cache remote from the data processing system 102 (e.g., a digital wallet, a crypto-wallet, other storage mediums or caches, etc.), such as on the client system 103 or the token exchange system 104.

In some arrangements, the cryptographic key processor 120 can sign the token using a private key and verify the token using a public key. In some examples, signing can include encrypting the token using a particular private key to create a digital signature, and verifying the token can include decrypting the token using a particular public key to verify the digital signature came from the particular private key or private address (e.g., a particular digital wallet of a user, etc.). In some arrangements, the cryptographic key processor 120 can sign the token using a public key and verify the token using a private key. In some examples, signing can include encrypting the token using a particular public key to create a digital signature, and verifying can include decrypting the token using a particular private key to verify the digital signature came from the particular public key or public address (e.g., a particular digital wallet of a user). It should be understood that a public key and a public address are used herein interchangeably, but in some arrangements, the public address may be a hashed version of the public key based on a hash function.

In some arrangements, the keys may be symmetric (e.g., use the same key to sign/verify) or asymmetric (e.g., use different keys to sign/verify). For example, each key of the public-private key pair may identical. In some arrangements, an algorithm (e.g., a hash algorithm, etc.) can be applied to a private key to generate a public key. In some examples, public keys can be a cryptographic code that allows users and systems described herein to receive digital assets and verify them prior to amending and/or updating a ledger (e.g., 168, 182).

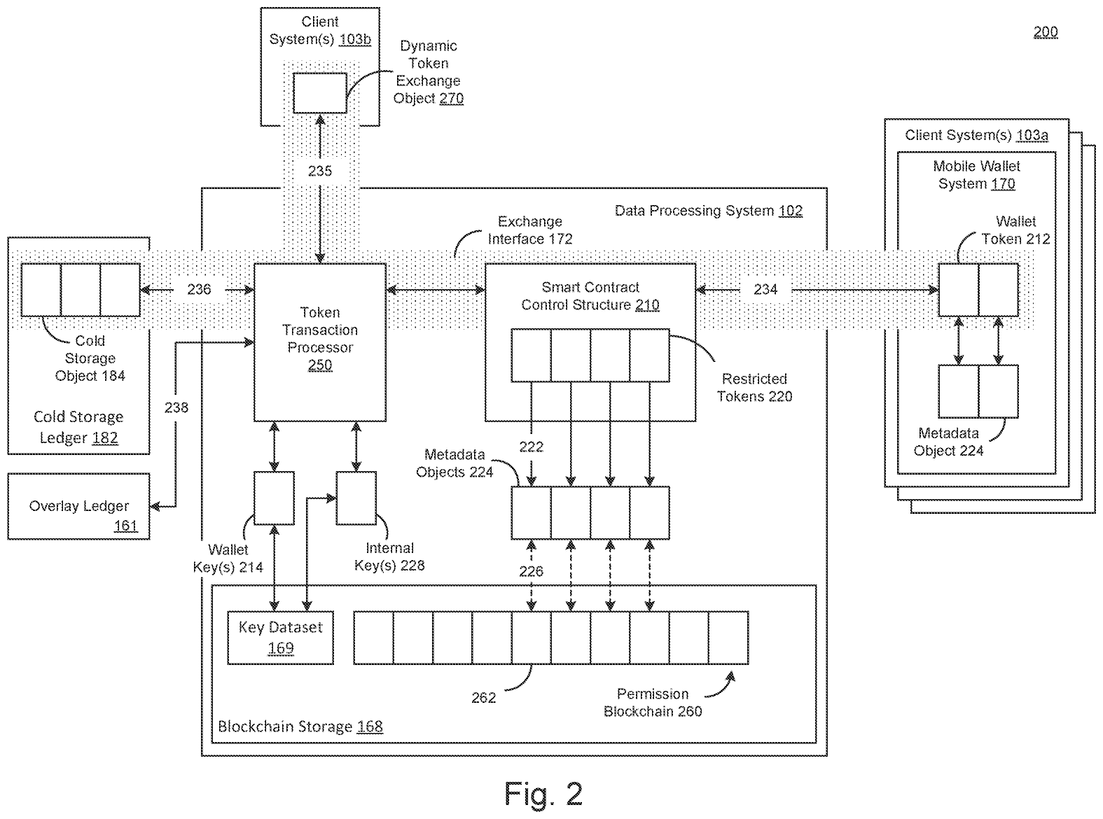

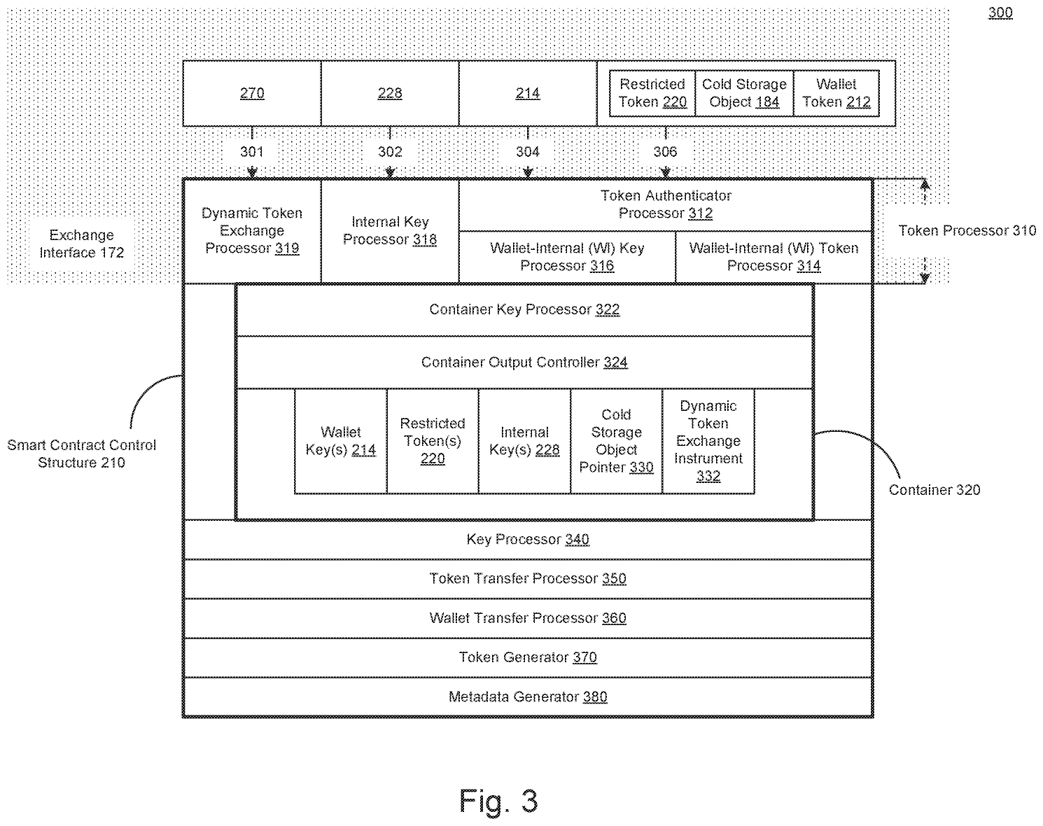

In some arrangements, generation of public-private keys can include concatenating multiple public-private key pairs into a single public-private key pair based on merging, using a math-based function, multiple key pairs. For example, a wallet public key or wallet public-private key pair can be provided by the mobile wallet system 170 with a token (e.g., for deposit). The cryptographic key processor 120 (and/or container key processor 322 of FIG. 3, as detailed herein) can generate a new internal public-private key pair prior to storing the token (e.g., restricted token 220 of FIG. 2, as detailed herein, etc.). Prior to storing the token, the cryptographic key processor 120 can improve security of the token by merging the wallet public key and the internal public key to create a new internal public key that includes both the wallet public key and the internal public key. The math-based function can be, but is not limited to, a Rivest-Shamir-Adleman, elliptic curve cryptography, Digital Signature Algorithm, asymmetric algorithm, hash algorithm or function, or symmetric algorithm, and so on. For example, executing the math-based function can include generating (or aggregating) a concatenated public key based on executing a concatenation of the wallet public key and the additional public key and hashing, utilizing salting, the concatenated public key based on a hash function, where salting includes providing random data and the concatenated public key as input to the hash function. In particular, the “salt” can be random data such as random bits that is used as an additional input to a one-way function such as a hashes or encryption algorithm. A new salt can be randomly generated by the cryptographic key processor 120 (and/or the container key processor 322) each time salting occurs. Salting can occur randomly to further protect public-private key pairs and salting can occur based on a preference of a user depositing the token or in response to analyzing metadata of the token (e.g., based on value of the token or data stored in a metadata object 224, as detailed herein, such as protected data). It should be understood that salting can be used to generate any public or private key described herein.

Still referring to FIG. 1, in some arrangements, the interface controller 112 can establish a data channel between a source address and a destination address, such that receivals or transmissions of a token occurs between the addresses on a ledger (e.g., the blockchain storage 168) and/or a digital wallet (e.g., the client system 103). An address can be generated based on executing, by the cryptographic key processor 120, a math-based function (e.g., hash, symmetric encryption, asymmetric encryption) on a public key of a public and private key pair (or a verification key of a verification and signing key pair). For example, if the interface controller 112 receives a token from any system or device described herein, the token or other data received may include metadata associated with a source address, and the interface controller 112 may determine a destination address (e.g., may be provided to the system sending the token in advance) to store the token in the blockchain storage 168. In various arrangements, the addresses may be a unique sequence of randomized (or pseudo-randomized) numerical digits, characters, punctuation, whitespace, code (e.g., QR), or symbols.

In some arrangements, the cryptographic key processor 120 can also be configured to generate public and private key pairs and the interface controller 112 can be configured to provide public keys (or public and private key pairs, or private keys) to one or more computing devices (e.g., the client system 103, the token exchange system 104, etc.) for use in a token exchange. The interface controller 112 can interface (e.g., using an API) with one or more other ledger systems (other blockchain ledgers) and wallets (e.g., digital, crypto, and so on). In various arrangements, the public and private key pair can be generated based on a cryptographic function (e.g., symmetric-key algorithms (Data Encryption standard (DES), Advanced Encryption Standard (AES), etc.), asymmetric-key algorithms (Ed25519 signing, Elliptic Curve Cryptography (ECC), etc.), public-key algorithms (Rivest-Shamir-Adleman (RSA), etc.), etc.) and be stored in the data processing system 102. In various arrangements, the keys of the public and private key pairs may be stored in separate locations. For example, public keys may be stored in the key dataset 169 and the private keys may be stored in a cold storage ledger 182. In some arrangements, the public and private key pairs may be stored together (as one data package) in the key dataset 169. In some arrangements, the data processing system 102 can maintain (e.g., store and access keys) the key dataset 169 such that each token may be locked-unlocked and associated with a public key or public-private key pair stored on the key dataset 169. In various arrangements, public-private key pairs can be shared amongst a plurality of tokens or can be unique to each token on the blockchain storage 168.

In various arrangements, the sender (e.g., a source party such as a user, a provider, or an entity) can utilize its private key (or public key) to generate a digital signature. The process of signing a message can use a mathematical operation that can be performed by the device (e.g., the client system 103, the token exchange system 104, etc.) of the sender who possesses the private key. The token and the digital signature can then be sent to a recipient. As will be appreciated, the recipient (e.g., destination party) can be a user, provider, and/or an entity (e.g., the data processing system 102) that can use the digital signature and the sender's public key (or private key) to verify that the sender is the signer of the token and that the integrity and origin authenticity of the token has not been compromised. In some arrangements, the tokens on the blockchain storage 168 may be associated with an account (e.g., designated in a field such as an account_ID field in the metadata of the token) (sometimes referred to herein as a “token account”).

In some arrangements, the ledger 161 provides a record of association for tokens with a token account. For example, the ledger 161 can associated a customer's account with one or more tokens transferred, stored, and/or monitored by the data processing system 102. The ledger 161 may be stored in system memory 160. Each token account for customers may be a single entry in the database. The blockchain storage 168 may be used to track exchanges (e.g., deposits, withdrawals, and updates of tokens) for each of the specific token accounts. The data processing system 102 updates the ledger 161 after each token exchange into and out of the blockchain storage 168. In certain situations, the data processing system 102 may update the ledger 161 without an exchange of a token into or out of the blockchain storage 168. For example, if a first customer wants to transfer a designated token (or portion of a token) to a second customer, and both customers are token account holders with the data processing system 102, the transfer may be effectuated by updating the ledger 161 without an actual exchange of a token in the blockchain storage 168. The transferring and exchanging of fungible and non-fungible values performed or executed by the one or more processors, according to various illustrative arrangements, is described in U.S. patent application Ser. No. 17/528,352, filed Nov. 17, 2021, the entirety of which is incorporated by reference herein.

Still referring to FIG. 1, the ledger 161 can store the associations of tokens with token accounts (e.g., the association between a token account and the tokens owned or partially owned by the token account), while the blockchain storage 168 can store portions of tokens (e.g., smart contracts containing information pointing to the off-chain content and metadata, such as data stored in the token storage 162) and keys of the token (e.g., stored in the key dataset 169). For example, the content and metadata of the token may be stored in an on-chain hash that can point to a storage location of the content and metadata.

The cold storage processor 180 can execute one or more actions with respect to generating (or creating), updating, protecting, and/or destroying cold storage objects in the cold storage ledger 182. In some arrangements, the cold storage processor 180 can communicate with the cold storage ledger 182 via an intermittent secure connection. In some arrangements, the process of establishing an intermittent secure connection can include disconnecting the data processing system 102 from all networks (e.g., internet connections, wired connections, etc.) and connecting via a wired network connection or a wired or wireless local network connection (e.g., local area network (LAN), intra-network, etc.). The connection can be intermittent or discontinuous since the data processing system 102 can perform many functions without having to access the cold storage ledger 182. However, in some arrangements, when an exchange of a token stored on the data processing system 102 is initiated, an intermittent secure connection may be established. In various arrangements, the customer with a token account or the data processing system 102 can add an attribute to each metadata object indicating whether a cold storage exchange must occur when exchanging the particular token. As used herein, “cold storage exchange” refers to the process of performing an exchange of a token using a cold storage object stored on the cold storage ledger 182.

In various arrangements, any data shared over the intermittent secure connection can be encrypted and/or secured (e.g., hashed, password protected, etc.) to prevent unauthorized parties from performing unauthorized actions on the intermittent secure connection. For example, a masking algorithm may be executed performing bitwise operations (e.g., NOT, AND, NAND, OR, XOR, Complement, left-shift (logical or arithmetic), right-shift (logical or arithmetic), rotate right, rotate left, etc.) on any data transferred over the intermittent secure connection. All communications over the intermittent secure connection can be encrypted with one or more secure network protocols (e.g., Secure Shell (SSL), Kerberos, IPSec, Secure Sockets Layer (SSL), Hypertext Transfer Protocol Secure (HTTPS), etc.) implemented utilizing a cryptographic function (e.g., symmetric encryption, asymmetric encryption, hashing, etc.). In some examples, the cryptographic function could be a homomorphic encryption function. In some examples, the cryptographic function could be any symmetric encryption function (e.g., Triple Data Encryption Standard (TDES), RC5, AES, Blowfish, CAST, etc.), and/or asymmetric encryption function (e.g., RSA, Efficient and Compact Subgroup Trace Representation (ECSTR or XTR), Digital Secure, Escrowed Encryption Standard (EES), etc.).

In general, a cold storage object can be a data structure that can be structured and formatted for storing data about tokens. For example, each token can include a linked metadata object and the metadata object may include protected and unprotected data. As used herein, “protected data” can include sensitive data such as, but not limited to, social security numbers (SSN), passport number, deoxyribonucleic acid (DNA), financial account number, other personal identifying information, biometric information, geolocation data indicating one or more locations of a person, photographs of people, criminal records, credit and/or payment card numbers, health data, and the like, whereas “unprotected data” can include data not considered sensitive data. In various arrangements, the data processing system 102 can analyze, based on accessing the link of the token, the metadata object to determine if any protected data is present. In some arrangements, when protected data is present, the cold storage processor 180 may update the metadata object by extracting the protected data and storing the protected data in a newly generated cold storage object. For example, the data processing system 102 can determine, via the link of the token, a first portion of metadata of the metadata object of the token associated with protected data of the token and a second portion of metadata of the metadata object of the token associated with unprotected data of the token, where the first portion of metadata does not contain any data from the second portion of metadata. In some examples, the cold storage processor 180 can remove or extract the first portion of metadata of the metadata object of the token based on accessing the metadata object via the link, and in turn generate a cold storage object with the protected data and the cold storage private key.

In some arrangements, a token transaction processor 250 of the data processing system 102, described more herein, can generate an unprotected public-private key pair of the token including the updating link with the second portion of metadata of the metadata object. In particular, the metadata object can be deconstructed to include the unprotected data prior to storing the token and can be reconstructed to include the protected data prior to performing an exchange. For example, a smart contract control structure can include code for executing a token reconstruction process to reconstruct the metadata object at the link of the token. Reconstruction can include updating the metadata object linked to the token to include protected data stored in a cold storage object and deconstruction can include updating the metadata object linked to the token to remove the protected data and store the protected data in the cold storage object.

In some arrangements, the process of generating a cold storage object can include storing a private key (e.g., internal private key, wallet private key, or both) in the cold storage object. The cold storage processor 180 may determine which private key or both to store in the cold storage object based on if the token is a multi-sig token or a single-sig token. As used herein, “multi-sig” refers to a signature scheme that enforces multiple signatures for an exchange before it may be successfully approved, whereas “single-sig” refers to a signature scheme that requires a single signature for an exchange before it may be successfully approved. For example, in a multi-sig token scenario, both the private keys may be stored in the cold storage object. In another example, in a single-sig token scenario, only one of the private keys may be stored in the cold storage object. In the following example, the internal private key may be stored in the cold storage object by default unless the customer requests their wallet private key be used.

In some arrangements, the process of storing the cold storage object can include disconnecting, by the cold storage processor 180, all internet connections on the data processing system 102, establishing an intermittent secure connection, generating a cold storage public-private key pair (including similar features and function of the public-private key pairs described above), and storing, via the intermittent secure connection, the cold storage object at the cold storage public address (e.g., hash of the cold storage public key). In the following process, the cold storage processor 180 can reconnect all the internet connections on the system after disconnecting from the intermittent secure connection. In some arrangements, the cold storage public-private key may not be generated and instead the internal public-private key pair or the internal private key may be stored in the cold storage object. Additionally, in some arrangements, any update or exchange of a token initiated by the blockchain storage 168 can be temporarily transferred to the cold storage ledger 182 to sign it before the exchange occurs on the blockchain storage 168. For example, each cold storage object on the cold storage ledger 182 can include a cold storage public-private key pair. Accordingly, in response to receiving an exchange from a public address of a token on the blockchain storage 168, the token transaction processor 250 can transfer, via an intermittent secure connection, the token to the cold storage processor 180 for reconstruction (if previously deconstructed) and signing, using the cold storage private key of the cold storage object. In particular, once reconstructed and/or signed, the token can be transferred to the destination address (e.g., wallet public address). In some embodiments, the blockchain storage 168 may also sign the token (after or before the cold storage private key) to “two-key sign” the token for additional security and protection, such that the destination address must verify (and sometimes in the correct order of signing using the private key) the token with both the cold storage public key and the internal public key. Thus, two-key signing using multiple private keys can improve the security of tokens.

Referring generally to the interplay and communication between the ledger 161, the blockchain storage 168, and the cold storage ledger 182, the token transaction processor 250 can facilitate the communication between each of the ledger 161, the blockchain storage 168, and the cold storage ledger 182. Additionally, the token transaction processor 250 can generate cold storage objects, establish intermittent secure connections with the cold storage ledger 182, generate and store token accounts in the ledger 161, communicate with the ledger 161 the recordation of tokens to token accounts, store keys in the key dataset 169 of the blockchain storage 168, and generate smart contract control structures 210 and link various features of tokens, including the metadata objects 224, with the permission blockchain 260 of the blockchain storage 168. The ledger 161 provides a record of association for the token with a token account, the blockchain storage 168 provides storage for one or more blockchains linked to one or more smart contracts, tokens, containers, or content objects, by corresponding addresses for particular smart contracts, tokens, containers, or content objects that indicate links with a particular blockchain, and the cold storage ledger 182 provides storage for one or more cold storage objects including a private key of a token and a portion of metadata of the metadata object of the token. In some arrangements, when an exchange occurs, each of the ledger 161, the blockchain storage 168, and the cold storage ledger 182 can execute various functions and code to deposit, withdraw, or update a token stored on the data processing system 102.

For example, a deposit of a token can include (1) updating the ledger 161 recording the token with a particular token account, (2) broadcasting the token to an internal public address on the blockchain storage 168, and (3) generating and storing a cold storage object in the cold storage ledger 182. In another example, an update of a token can include (1) broadcasting the updated token to an internal public address on the blockchain storage 168 and/or (2) generating and storing a new cold storage object (sometimes may be skipped) in the cold storage ledger 182, and since the token is still associated with the account, the ledger 161 may not be updated. In yet another example, a withdrawal or transfer of a token within the data processing system 102 (e.g., between accounts stored on the ledger 161) can include (1) updating the ledger 161 recording the token with a different token account and/or (2) generating and storing a new cold storage object (sometimes may be skipped) in the cold storage ledger 182, and since the token is still associated with an account on the ledger 161, the blockchain storage 168 may not be updated. In yet another example, a withdrawal or transfer of a token outside the data processing system 102 (e.g., between at least one account not stored on the ledger 161) can include (1) updating the ledger 161 removing the association of the token with a particular token account, (2) transferring the token to an un-spendable address on the blockchain storage 168, and (3) removing or destroying the cold storage object in the cold storage ledger 182.

Still referring to FIG. 1, in some arrangements, the data processing system 102 may receive a deposit of tokens from the client system 103, and the client system 103 may have an account with the data processing system 102. In the following example, the data processing system 102 may encapsulate and deposit the token (e.g., after verifying the digital signature) on the data processing system 102. Additionally in some arrangements, a deposit can include extrapolating (by the token feature processor 130) various information from the token and storing the information in various storages (e.g., blockchain storage 168, ledger 161, cold storage ledger 182). In one example, a deposit of a token can include updating (e.g., by a ledger 161) a token account of a plurality of token accounts in a ledger 161 by recording ownership of the token with the token account. In the following example, a deposit can further include generating and storing (e.g., by a cold storage processor 180) a first cold storage object in a cold storage ledger 182, where the first cold storage object can include the wallet private key (or internal private key) of the token and at least a first portion of metadata of the metadata object of the token. In the following example, a deposit can further include broadcasting (e.g., by a blockchain storage 168) the token to the blockchain storage 168 at the internal address (e.g., hash of an internal public key).

As used herein, “wallet keys” (including wallet public-private key pairs, wallet public key, and wallet private key) can be cryptographic keys of a token used by the client system 103 to sign the token, verify the token, and protect the token. As used herein, “internal keys” (including internal public-private key pairs, internal public key, and internal private key) can be cryptographic keys of a token used by the data processing system 102 to sign the token, verify the token, and protect the token.

In some arrangements, verifying and/or authenticating the token can further include communicating (e.g., by the interface controller 112) with other systems (e.g., ledgers or digital wallets) to notify the other systems that the token was verified and/or authenticated (e.g., transferred and stored on the data processing system 102). For example, the client system 103 may provide a signed token to the data processing system 102. In the following example, the data processing system 102 can receive the token and perform verification and/or authentication. Upon verifying and/or authenticating, the data processing system 102 may notify (e.g., send a message) the client system 103 or the token exchange system 104 (e.g., whoever transmitted the token) that a token was (or a plurality of tokens were) verified and/or authenticated. Further in this example, the client system 103 or the token exchange system 104 may in turn destroy or update the digital wallet (or ledger) based on the successful verification. In some arrangements, when the token (or tokens) are transferred between computing systems or devices, the sender's ledger or wallet may be voided since the public-private key pair would be invalid (e.g., cannot be used to sign or verify an exchange). That is, while the ledger or wallet may not destroy or update the token when they are transferred to the data processing system 102, the token on the sender's ledger or wallet would be unusable or unvalued.

In some arrangements, the interface controller 112 may receive a withdrawal or exchange request of one or more tokens stored on the data processing system 102, where a user (e.g., operating the client system 103) may have an account with the data processing system 102. Further in this example, the data processing system 102 may in turn destroy the token and/or update the storages (e.g., 161, 168, 182) based on the successful withdrawal or exchange. In some arrangements, when a token is exchanged between the data processing system 102 and another ledger or wallet (e.g., digital wallet of client system 103 or the token exchange system 104), the token may be voided or burned since the public-private key pair would be invalid (e.g., cannot be used to sign or verify an exchange). Voiding or burning can include transmitting the token to an un-spendable address (e.g., where no one knows the private key). That is, while the blockchain storage 168 may not destroy or update the token when they are exchanged to a different ledger or off-chain, the token on the sender's ledger would be unusable or unvalued.

Referring to the blockchain storage 168 (sometimes referred to herein as a “blockchain ledger”) described herein generally. The blockchain storage 168 (or ledger) can include the key dataset 169 and a blockchain. The blockchain storage 168 can be configured to store and/or maintain any of the information described herein (e.g., tokens or portions of tokens, smart contracts, public and private key pairs, etc.). In some arrangements, the described ledger systems and methods involve utilizing one or more processors. The one or more processors allow receiving, collecting, and sending of environmental data, exchange requests (e.g., withdrawal, deposit), public and private key pairs, attributes, smart contracts, and so on. The one or more processors can then communicate with one or more nodes of the blockchain storage 168 and execute one or more smart contracts stored on the nodes to perform various checks (e.g., signing, verifying, distributing, exchanging).

Still referring to FIG. 1, in various arrangements, the key dataset 169 can include a plurality of public and private key pairs (referred to hereafter as “key pairs”). In some arrangements, the key dataset 169 may include a public key and a pointer (e.g., cold storage public key, hash address, or cold storage address) to a cold storage object (e.g., a cold storage object 184 of FIG. 2, as detailed herein) stored in cold storage ledger 182. In some arrangements, the key dataset 169 can include a hardware security module (HSM) that can manages cryptographic keys. Each key pair can be stored in the key dataset utilizing a cryptographic function. For example, the cryptographic function could be a homomorphic encryption function. In another example, the cryptographic function could be any symmetric encryption function (e.g., TDES, RC5, AES, Blowfish, CAST, and so on), and/or asymmetric encryption function (e.g., RSA, ECSTR or XTR, Digital Secure, EES, and so on). In some arrangements, the private key can be used to encrypt tokens (e.g., using a cryptographic function to sign) at the source system when an exchange occurs (e.g., send token from a source address to a destination address). In various arrangements, the public key can be used by the destination system to decrypt (e.g., verify) the encrypted token. For example, the sender (source) of a token stored in a digital wallet can sign (e.g., “lock”) the token or data package including the token to be exchanged with a private key stored in a digital wallet or on the user device (e.g., 103) of the user and in turn, transmit the token and share the public key for verifying (e.g., “un-locking”) by the receiver, such as the data processing system 102. Additionally in some arrangements, the public key can be used to encrypt tokens and the private key can be used to decrypt the encrypted tokens. For example, the sender (source) of a token stored in a digital wallet can sign the exchange with a public key of and shared by the receiver (destination), and the receiver can in turn, verify the received token and/or data package including the token using the private key of the receiver.

In some arrangements, the blockchain storage 168 can include a plurality of nodes configured to store a copy of a plurality of tokens. In various arrangements, each node may contain a copy of an individual token associated with a token account of the data processing system 102. In various arrangements, the plurality of nodes on the blockchain storage 168 can be interconnected via a central node (e.g., centralized or generalized). Indeed, each node can perform various operations (e.g., execute smart contracts, update tokens) on-chain (e.g., on blockchain storage 168) or off-chain. Thus, the central node can operate as an intermediary between any system or device with data not stored on the blockchain storage 168 such that, any communications (e.g., exchange requests, withdrawals or deposits, updates, public and private key access) first is received by the central node. As such, the central node may be configured to route communications and/or query one or more nodes on the blockchain storage 168 upon receiving a communication from any system or device described herein. In some arrangements, the central node may be a token and may be the root node (e.g., the originally created token), and any additional nodes added may be attached (e.g., appended, pre-pended, linked, associated, embedded) to the central node via one or more communications networks (e.g., public, private, shared, and so on). In various arrangements, the central node may be a dummy asset that stores data (e.g., addresses) to communicate with the other nodes on the blockchain storage 168.

Alternatively, the plurality of nodes on the blockchain storage 168 could be interconnected with the plurality of nodes to form a peer-to-peer network (e.g., distributed ledger network). In the following arrangement, instead of a central node operating as an intermediary, each node may contain a copy of a plurality of tokens stored and maintained by the data processing system 102 and can operate as an individual intermediary which may contain a copy of the plurality of tokens stored and maintained by the data processing system 102. Additionally, each node could be configured to determine functions to perform (e.g., execute a smart contract, send public key, update token, etc.) based on communications. While various circuits, interfaces, and logic with particular functionality are shown, it should be understood that the blockchain storage 168 can include any number of circuits, interfaces, and logic for facilitating the functions described herein. For example, the activities of multiple circuits (or processors) may be combined as a single circuit and implemented on a single processing circuit, as additional circuits with additional functionality are included.

The data processing system 102 (in particular, the token transaction processor 250) can be configured to process exchanges of tokens (e.g., withdrawal, deposit, update) and may be configured to perform various actions and/or access various types of data or metadata, some of which may be provide over the network 101. In particular, the token transaction processor 250 can be configured to process token exchanges based on received public keys (or public and private key pairs, or private key), environmental data, off-chain data, and metadata of one or more tokens stored by and on the data processing system 102 (e.g., in 161, 168, 182) from the systems and devices described herein. In some arrangements, exchanges of tokens on-chain or off-chain include utilizing a control structure specific to the token or group of tokens. Although the FIGS. and specification generally discuss utilizing control structures on token exchanges (e.g., withdrawals, deposits, updates), the systems, methods, and apparatuses disclosed herein can also be used for a plurality of tokens such as, but not limited to, utility tokens, security tokens, payment tokens, exchange tokens, decentralized finance (DeFi) tokens, stablecoins, asset-backed tokens, privacy tokens, fungible tokens, non-fungible tokens, and so on. Additional details and examples relating to exchanging tokens are described in detail with reference to FIGS. 2-4.

In various arrangements, the data processing system 102 further includes a dynamic token exchange instrument printer 122 that can be hard wired or wireless to the system processor 110. The dynamic token exchange instrument printer 122 can be configured to generate, update, and store dynamic token exchange instruments. For example, the dynamic token exchange instruments can be stored in a container 320 (detailed herein with respect to FIG. 3) of a smart contract control structure 210 (detailed herein with respect to FIG. 2) and be associated with one or more tokens. The dynamic token exchange instrument printer 122 can include a printer that can print a physical dynamic token exchange instrument 173. For example, the dynamic token exchange instrument printer 122 can be a financial card printer including an e-paper, e-ink, or display manufacturing device. For example, the dynamic token exchange instrument printer 122 can be a financial card printer including an e-paper, e-ink, or display manufacturing device. In another example, dynamic token exchange instrument printer 122 can be an industrial card printer, encoder, or laser engraver that can manufacture the card and an LCD or similar display can be manufactured by a display manufacturing machine (e.g., CRT, LCD, LED, plasma, OLED, and so on). Accordingly, the dynamic token exchange instrument printer 122 can be configured to print a payment card that can include a display for presentation (e.g., the physical dynamic token exchange instrument 173). In some arrangements, the physical dynamic token exchange instrument 173 may not include a display.

In various arrangements, the physical dynamic token exchange instrument 173 can include a network interface and a display element. The network interface (sometimes referred to herein as a “network circuit”) can allow the computing systems and devices to communicate wirelessly or otherwise with the physical dynamic token exchange instrument 173. The network interface may be implemented via hardware (e.g., circuitry), software (e.g., executable code), or any combination thereof. Thus, the physical dynamic token exchange instrument 173 can be configured to communicate and establish a communication session with the client system 103 and/or the data processing system 102 via the network 101. Establishing a communication session between the physical dynamic token exchange instrument 173 and the client system 103 can include establishing a Bluetooth, NFC, WAN, or any short range communication mechanism or protocol.

In various arrangements, the client system 103 can disable and enable the display features of the presentation element(s) of the physical dynamic token exchange instrument 173 such that presentation of various elements (e.g., image of an NFT, balance, current limit) can be disabled or removed at any given time in response to a request by the client system 103. Furthermore, the presentation of various elements can be disabled or removed at any given by the physical dynamic token exchange instrument 173 in response to losing connection to the client system 103. Additionally, the dynamic token exchange instrument printer 122 can include an output feed configured to print and dispense the physical dynamic token exchange instrument 173.

FIG. 2 depicts an example protection architecture, in accordance with present implementations. As illustrated by way of example in FIG. 2, an example system architecture 200 can include at least the data processing system 102, the client system 103a, the client system 103b, the ledger 161, the blockchain storage 168, the key dataset 169, the mobile wallet system 170, the exchange interface 172, the cold storage ledger 182, the cold storage object 184, a smart contract control structure 210, wallet tokens 212, wallet key(s) 214, one or more restricted tokens 220, one or more metadata links 222, one or more metadata objects 224, one or more blockchain links 226, internal key(s) 228, a client link 234, a client link 235, a cold storage link 236, a ledger link 238, a token transaction processor 250, a permission blockchain 260 with one or more blocks 262, and a dynamic token exchange object 270.

The mobile wallet system 170 can include one or more tokens and keys corresponding to a various accounts and linked with the client system 103a. For example, the mobile wallet system 170 can encapsulate one or more tokens linked with the client system 103a within a secure container, and can include an interface compatible with the token transaction processor 250, the token exchange system 104, and the exchange interface 172. The mobile wallet system 170 can include wallet tokens 212. The wallet tokens 212 can each include a particular token and can correspond to particular metadata objects 224. A token of the wallet tokens 212 can be associated with a particular metadata object 224, and can be required to transmit output of the metadata object 224, transfer the metadata object 224 to another storage location, or any combination thereof, for example. Each of the wallet tokens 212 can indicate control of a particular metadata by a particular user linked with the mobile wallet system 170 via a cryptographic key or key pair.

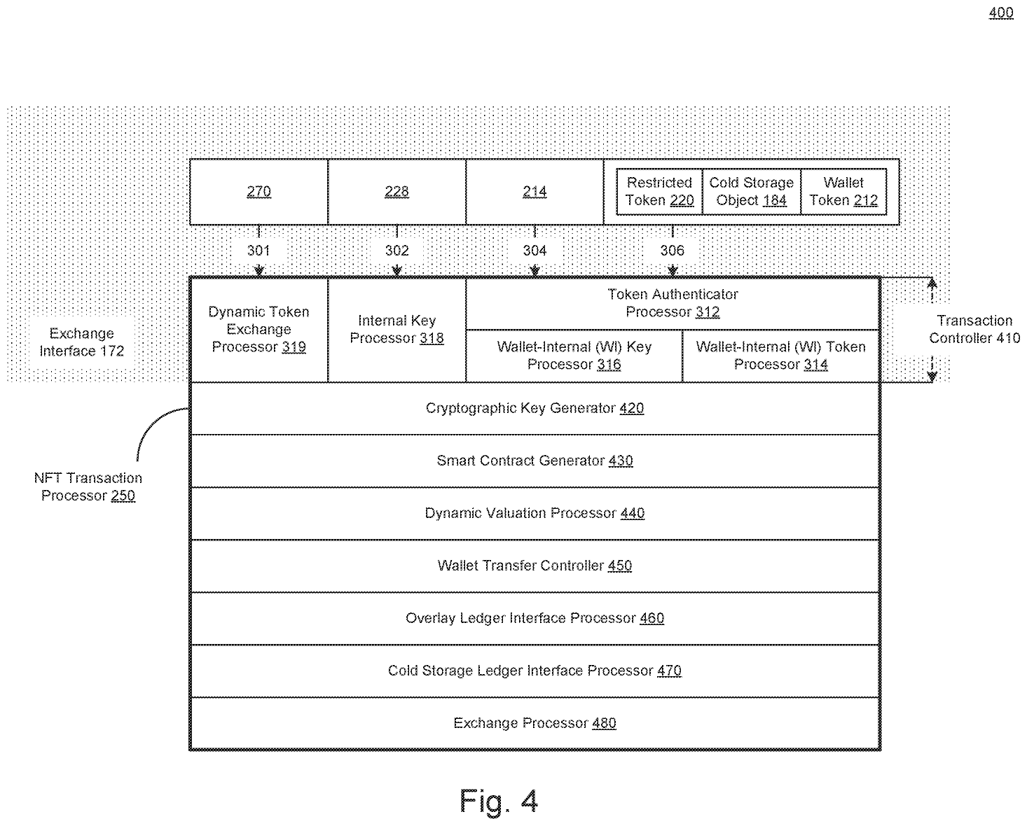

The wallet key(s) 214 can include a key compatible with the wallet token 212. The wallet key(s) 214 can be stored in the key dataset 169 and received by a token authenticator processor 312 via a wallet key transmission 304 (as disclosed herein with respect to FIGS. 3 and 4). The mobile wallet system 170 can execute a transaction or modify metadata of the wallet token 212 in response to detecting input including the wallet key 214. The wallet keys 214 can, for example, include a wallet public-private key pair, a wallet public key, or a wallet private key compatible with the mobile wallet system 170. The mobile wallet system 170 can permit access to the wallet token 212 based on the wallet key(s) 214, for example, compatible with the encapsulation layer and operable to decrypt the encryption corresponding to the encapsulation layer.

The smart contract control structure 210 can include one or more instructions to restrict and transmit output of one or more of the restricted tokens 220. The smart contract control structure 210 can correspond to an executable smart contract and can include a gateway component. The gateway component can include one or more instructions to restrict or prevent output of the restricted tokens 220 in the absence or presence of one or more tokens compatible with the smart contract control structure 210. The smart contract control structure 210 can include an encapsulation layer that (shown as smart contract control structure 210), for example, maintains the restricted tokens in an encrypted state. The smart contract control structure 210 can permit access to the restricted tokens based on a private key, for example, compatible with the encapsulation layer and operable to decrypt the encryption corresponding to the encapsulation layer. The gateway component can be compatible with and interface with the exchange interface 172, and the encapsulation layer can be integrated with the smart contract control structure 210. The smart contract control structure 210 can be registered to the permission blockchain 260 by a block link with the permission blockchain 260.

The restricted tokens 220 can each include a particular token and can correspond to particular metadata objects 224. A restricted token 220 can be associated with a particular metadata object, and can be required to transmit output of the metadata object, transfer the metadata object to another storage location, or any combination thereof, for example. Each of the restricted tokens 220 can indicate control of a particular metadata object of the metadata objects 224 by a corresponding metadata link of the metadata links 222. The metadata links 222 can include a reference, pointer, or the like, to or between each restricted token and each metadata object associated with that particular restricted token. The restricted tokens 220 can have various aspects or characteristics, for example, that can correspond to the wallet tokens 212. For example, a restricted token among the restricted tokens 220 can be associated with a type corresponding to or matching a type of the wallet token 212. The client link 234 can include a technical improvement of at least including a format, protocol, or the like compatible with the client system 103a, by detecting or identifying aspects or characteristics of the restricted tokens 220.

A token of the restricted tokens 220 can be transferred from or to the mobile wallet system 170. For example, each of the restricted tokens 220 can indicate control of a particular metadata by a particular user linked with the smart contract control structure 210 via the internal key 228. The internal key 228 can include a key compatible with and controlled by the data processing system 102. Transmission of the internal key 228 can be restricted by the data processing system 102 to within the data processing system 102. For example, the internal key 228 can correspond to a “backup key” or “house key” that must be detected in order to activate processors or decrypt containers of the smart contract control structure 210. Thus, the internal key 228 can restrict authorization by the smart contract control structure 210 to the data processing system 102 environment.

The metadata objects 224 can each include a particular data or instructions. A metadata objects can correspond to a collections of executable instructions or data that can be finite. For example, a metadata object can include a video file corresponding to a limited number of instances of video metadata. For example, a metadata object can include an audio file corresponding to a limited number of instances of audio metadata. For example, a metadata object can include a metric that increases with limited capacity, such as a physical measurement a financial instrument valuation, a periodic output based on a physical or scarce property, or any combination thereof.

The exchange interface 172 can include a communication channel between one or more of the smart contract control structure 210, the token transaction processor 250, the wallet token 212 at the mobile wallet system 170, and the cold storage object 184 at the cold storage ledger 182. The exchange interface 172 can include an application programming interface compatible with the smart contract control structure 210 to detect the wallet key(s) 214 and the internal key(s) 228 at the data processing system 102, the cold storage object 184 at the cold storage ledger 182, and the wallet token 212 at the mobile wallet system 170. At least one of the exchange interface 172 or the smart contract control structure 210 can execute one or more instructions to determine whether one or more of the wallet key 214, the internal keys 228, the dynamic token exchange object 270, or the wallet token 212 are compatible with the container 320 (detailed herein with respect to FIG. 3) and/or smart contract control structure 210. The exchange interface 172 can include the wallet token 212 and the client link 234. The client link 234 can include a transmission path or communication path between the wallet token 212 and the smart contract control structure 210 by the exchange interface 172. At least one of the exchange interface 172 or the smart contract control structure 210 can detect the wallet token 212 via the client link 234.

The wallet token 212 can identify a token and can identify one or more characteristics linked with the token or corresponding to a request to transfer the token (e.g., deposit, withdrawal, update). For example, the wallet token 212 can include an identifier of the token, a hash of the token, an identifier of a token account linked with the token, a token account linked with the request to transfer the token, an identifier of a public-private key pair or any portion thereof, or any combination thereof. For example, the wallet token 212 can include an identification of a public-private key pair corresponding to a smart contract control structure of an owner of a token. In another example, the wallet token 212 can include an identification of a public-private key pair corresponding to a smart contract control structure of a buyer of a token. The client link 234 can transmit the wallet token 212 from the client system 103a or the mobile wallet system 170 to the data processing system 102 (in particular, the token transaction processor 250) or the smart contract control structure 210.

The token transaction processor 250 can execute one or more actions with respect to various cryptographic keys, tokens, containers, control structures, and smart contracts. For example, the token transaction processor 250 can modify links between various containers, control structures, token, and smart contracts with various public-private key pairs. The token transaction processor 250 can transfer public-private key pairs based on one or more operations of the cryptographic key processor 120, for example. The token transaction processor 250 can generate and modify one or more metrics corresponding to various tokens, including the wallet tokens 212 and the restricted tokens 220, based on one or more operations of the token feature processor 130 or the token metrics engine 140. The token transaction processor 250 can generate or modify one or more containers, tokens accounts, or smart contracts, based on one or more operations of the smart contract engine 150.

The token transaction processor 250 can execute one or more actions with respect to generating the cold storage objects 184 and storing the cold storage objects 184 in the cold storage ledger 182. In some arrangements, the token transaction processor 250 can establish an intermittent secure connection with the cold storage ledger 182 over the cold storage link 236. The token transaction processor 250 can also execute one or more actions with respect to generating token accounts for the ledger 161, recording associations of restricted tokens 220 with one or more token accounts of the ledger 161, and updating the ledger 161. In some arrangements, the token transaction processor 250 can establish a connection with the ledger 161 over the ledger link 238.

The permission blockchain 260, within the blockchain storage 168, can include at least one blockchain including one or more of the blocks 262. The permission blockchain 260 can be linked with one or more of the metadata objects 224, the restricted tokens 220, or the smart contract control structures 210. The permission blockchain 260 can include a blockchain operated and controlled at the data processing system 102. The permission blockchain 260 can include a plurality of blockchains each corresponding to particular aspects of the links associated with the corresponding blockchains. The permission blockchain 260 can include the blocks 262, and the key dataset 169 can include the wallet keys 214, the internal keys 228, and/or other keys such as cold storage keys. The blocks 262 can include or store links to one or more objects associated with the permission blockchain 260. The keys stored in the key dataset 169 can include a reference, pointer, or the like, to or between a block among the blocks 262 and the keys associated with that particular block. For example, the internal key 228 can include a reference, pointer, or the like, to or between a block among the blocks 262 and the internal key 228 associated with that particular block.

For example, the data processing system 102 can transfer, by the token transaction processor 250 and based on a scaled value of a token, a second public and private key pair to the smart contract linked with a second scaled value of the token and the token. The data processing system 102 can include the second scaled value of the token corresponding to a difference between a quantitative value of the token and the scaled value of the token. The difference can correspond to a value of the token that exceeds a value of a transaction identified by a request token. For example, the system can extract, by the token transaction processor 250 from a first metadata object (e.g., the metadata object 224, etc.) linked with the token, a type of heuristic that indicates the type of the token satisfying the type of heuristic. For example, a type of heuristic can identify presence of pixels, video frames, or vector definitions, and can indicate that a token is linked with a metadata object having an image, video, or icon format. For example, a type of heuristic can identify presence of hashes, or asymmetric key pairs, and can indicate that a token has a hash type or a key-based linking property.

In some arrangements, the client system 103b may be a point-of-sale device or similar payment receival device configured to receive payment requests (e.g., from a digital or physical payment instrument) from a customer (e.g., operating a different client system 103). For example, client system 103b can be configured to accept payment cards (e.g., credit card, debit card, rewards card, tap card) or another payment instrument (e.g., token from a digital wallet, digital payment card) such as, but not limited to, the physical dynamic token exchange instrument 173 or a digital dynamic token exchange instrument. In general, the physical dynamic token exchange instrument 173 or the digital dynamic token exchange instrument can transmit information (e.g., identifier, expiration date, one-time code or token) unique to the physical dynamic token exchange instrument 173 or the digital dynamic token exchange instrument. In some arrangements, the client system 103b or the physical dynamic token exchange instrument 173 or the digital dynamic token exchange instrument can generate the dynamic token exchange object 270 including dynamic token exchange instrument information of the dynamic token exchange instrument and exchange information (e.g., public address of the exchange system, routing information to receive payment, exchange system identifier, public-private key pair, and so on) of the one exchange system. In particular, the dynamic token exchange object 270 can be used by the token transaction processor 250 to process exchanges between the customer presenting and using the physical dynamic token exchange instrument 173 or the digital dynamic token exchange instrument and the provider. Processing exchanges can include using current card network rails to transfer payment from the customer to the provider.

The token transaction processor 250 can execute one or more actions with respect to receiving the dynamic token exchange object 270 from client system 103b. The client system 103b can be a point-of-sale device or similar payment receival device configured to accept the physical dynamic token exchange instrument 173 (e.g., via an NFC tap or swipe) and/or digital dynamic token exchange instrument (e.g., from a short range communication between the client system 103b and another of the client systems 103). In some arrangements, the token transaction processor 250 can establish a secure connection with the client system 103b over the client link 235. The exchange interface 172 can include the dynamic token exchange object 270 and the client link 235. The client link 235 can include a transmission path or communication path between the dynamic token exchange object 270 and the token transaction processor 250 by the exchange interface 172. At least one of the exchange interface 172 or the token transaction processor 250 can detect the dynamic token exchange object 270 via the client link 235. The container 320 can include one or more dynamic token exchange instruments 332 (as detailed herein with respect to FIG. 3).

FIG. 3 depicts an example protection architecture, in accordance with present implementations. As illustrated by way of example in FIG. 3, an example protection architecture 300 can include at least the exchange interface 172, the smart contract control structure 210, a dynamic token exchange transmission 301, an internal key transmission 302, a wallet key transmission 304, and a token/object transmission 306, a token processor 310 including a token authenticator processor 312, a wallet-internal token processor 314, a wallet-internal key processor 316, and an internal key processor 318, a dynamic token exchange processor 319, a container 320, a key processor 340, a token transfer processor 350, a wallet transfer processor 360, a token generator 370, and a metadata generator 380.

The internal key transmission 302 can be responsive to an action by the exchange interface 172 to transmit the internal key 228 to the smart contract control structure 210. The wallet key transmission 304 can be responsive to an action by the exchange interface 172 to transmit the wallet key 214 to the smart contract control structure 210. The token/object transmission 306 can be responsive to an action by the exchange interface 172 to transmit the wallet token 212, the restricted token 220, and/or the cold storage object 184 to the smart contract control structure 210. That is, the token/object transmission 306 can be one or more of the wallet token 212, the restricted token 220, and/or the cold storage object 184 received from one or more of the cold storage ledger 182, the blockchain storage 168, and/or the mobile wallet system 170, via the exchange interface 172.

For example, to sign a restricted token 220 in the smart contract control structure 210 prior to an exchange, the token processor 310 (in particular, the token authenticator processor 312) may request, over the exchange interface 172, the cold storage object 184 from the cold storage ledger 182. The request may include a cold storage object pointer 330 from the container 320. In the above example, the token processor 310 may establish an intermittent secure connection by disconnecting the data processing system 102 from the internet or any network connection prior to transmitting the request to the cold storage object 184. In another example, to make a deposit on the data processing system 102, the mobile wallet system 170 can transmit the wallet token 212 (and a wallet public key, wallet private key, and/or wallet public-private key pair) to the smart contract control structure 210 or to the token transaction processor 250 for processing the output. In the example when the token transaction processor 250 receives the wallet token 212 first, the token transaction processor 250 may verify, authenticate, or sign the wallet token 212 (or portions of the wallet token 212 such as the link or metadata object) prior to transmitting the wallet token 212 to the smart contract control structure 210. In yet another example, to make a withdrawal on the data processing system 102, the blockchain storage 168 and/or key dataset 169 can transmit the restricted token 220 (and an internal public key, internal private key, internal public-private key pair, and/or the cold storage object 184) to the smart contract control structure 210 or to the token transaction processor 250 for processing the output. In the example when the token transaction processor 250 receives the restricted token 220 first, the token transaction processor 250 may verify, authenticate, or sign the restricted token 220 (or portions of the wallet token 212 such as the link or metadata object) prior to transmitting the restricted token 220 to the smart contract control structure 210.

Additionally, the token processor 310 can query the ledger 161 for token account information associated with the restricted token 220 or the wallet token 212. For example, in response to the token processor 310 receiving the restricted token 220 or the wallet token 212, the token authenticator processor 312 can determine if a token account has been generated for the received restricted token 220 or the wallet token 212. In the above example, if a token account has been created, the token processor 310 may update the ledger 161 recording the token identifier with a particular token account. In yet the above example, if a token account has not been created, the token processor 310 may provide the ledger 161 with information to generate a token account and record the token identifier with the newly generated token account.

The token processor 310 can communicate with, authenticate, and update various tokens and NFTs. The token processor 310 can include one or more interfaces corresponding to an API or a smart contract interface, for example. A smart contract interface can include one or more executable instructions integrated with a smart contract. The smart contract interface can execute instructions at the smart contract or triggered by the smart contract in response to detection of objects or conditions external to the smart contract. The token processor 310 can include at least a portion of a control structure of the smart contract.

The internal key processor 318 can detect the presence of the internal key 228 (e.g., internal public key, internal public-private key pair, internal private key), and can determine whether the internal key 228 is compatible with the internal key processor 318. The internal key processor 318 can be configured to be compatible with a particular internal key of the internal keys 228, or can be generated to be compatible with the particular internal key. For example, the internal key processor 318 can be integrated with or store a hash based on the internal key 228 and a hash processor operable to generate a hash based on any system internal key 228. For example, the internal key processor 318 can include a public key or a private key of a key pair of the internal key 228, and can authenticate at least a portion of the internal key 228 based on a hash or comparison with the portion of the internal key 228. The internal key processor 318 can generate a hash in response to detecting the presence of the internal key 228, and can determine whether the internal key 228 is compatible with the smart contract control structure 210, in response generating the hash, by comparing the generated hash with the stored hash. The internal key processor 318 can include logic to detect the internal key 228 passed to it, by, for example, a JSON object or a header argument.

The token authenticator processor 312 can determine whether a token of the container 320 of the smart contract control structure 210 is compatible with an exchange (e.g., withdrawal, deposit, update). For example, the token authenticator processor 312 can include one or more metrics indicating that tokens having aspects or characteristics that can be transferred to or from the smart contract control structure 210. For example, a particular token in the container 320 of the smart contract control structure 210 may be incompatible with a transfer (e.g., deposit, withdrawal) or restricted from transfer by a minting restriction. For example, the token authenticator processor 312 can include or reference a transfer restriction linked with a minting restriction, and can block execution of a transfer of the token from or to the mobile wallet system 170 in response to detecting the minting restriction or transfer restriction. For example, the token authenticator processor 312 can include or reference a transfer authorization linked with a minting parameter, and can permit or initiate execution of a transfer of the token from or to the blockchain storage 168 in response to detecting the minting parameter linked with the transfer authorization. For example, the token authenticator processor 312 can link with the smart contract control structure 210 and receive an identification of or reference to a particular token. The token authenticator processor 312 can then determine one or more characteristics or aspects of the particular token associated with the request to transfer the particular token, in response to receiving a transmission from or via the mobile wallet system 170 and/or the token transaction processor 250.

The token authenticator processor 312 can detect the presence of a fungible token or non-fungible token, and can determine whether the token is compatible with the smart contract control structure 210. The token authenticator processor 312 can be configured to be compatible with a particular fungible token, or can be generated to be compatible with a particular fungible token. The token authenticator processor 312 can be configured to be compatible with a plurality of tokens having a particular characteristic, or can be generated to be compatible with a plurality of tokens having a particular characteristic. A particular characteristic can include, for example, a particular identifier or portion of an identifier of a token. For example, the token authenticator processor 312 can be integrated with or store a hash based on a particular fungible token and a hash processor operable to generate a hash based on any fungible token. The token authenticator processor 312 can generate a hash in response to detecting the presence of the fungible token, and can determine whether the fungible token is compatible with the smart contract control structure 210, in response generating the hash, by comparing the generated hash with the stored hash. The token authenticator processor 312 can include logic to detect a fungible token passed to it, by, for example, an activation instruction from the exchange interface 172.

In some arrangements, the token authenticator processor 312 can authenticate links of tokens based on successfully accessing, via the link, the metadata object of the tokens. The link can be the TokenURI (a unique identifier of what the token “looks” like) or another link that can be provided to a token lookup table, a Uniform Resource Locator (URL), a world-wide-web address, an internal network address, a Hypertext Transfer Protocol Secure (HTTPS), an Interplanetary File System (IPFS) hash, and so on. In various arrangements, authenticating the link can include scanning and/or analyzing a token exchange, such as the token exchange system 104, to verify the received token is not stored on or being sold on the token exchange. In some arrangements, the token authenticator processor 312 can also collect on-chain data related to the token by accessing the previous public address (prior to transferring the token and encapsulating it within the smart contract control structure 210) and determine if the on-chain data (e.g., previous transaction history, owner, metadata, etc.) is consistent with the metadata of the received token.

The wallet-internal token processor 314 can detect the presence of the wallet token 212, the restricted token 220, and/or the cold storage object 184, and can extract one or more attributes, parameters, aspects, or values, or any combination thereof, from at least one of the wallet token 212, the restricted token 220, and/or the cold storage object 184. The wallet-internal token processor 314 can be configured to be compatible with the wallet token 212, the restricted token 220, the cold storage object 184, the exchange interface 172, the token exchange system 104, and/or the mobile wallet system 170. Thus, the wallet-internal token processor 314 can provide a technical improvement of direct communication between the data processing system 102, the mobile wallet system 170, the token exchange system 104, the cold storage ledger 182, and the ledger 161. The wallet-internal token processor 314 can include a token profile or exchange profile corresponding to a particular token exchange system and compatible with a particular token.

The wallet-internal token processor 314 can detect the presence of a semi-fungible token (or non-fungible token (NFT)), and can determine whether the semi-fungible token is compatible with the wallet-internal token processor 314. The wallet-internal token processor 314 can be configured to be compatible with a particular semi-fungible token, or can be generated to be compatible with a particular semi-fungible token. The wallet-internal token processor 314 can be configured to be compatible with a plurality of tokens having a particular characteristic, or can be generated to be compatible with a plurality of tokens having a particular characteristic. A particular characteristic can include, for example, a particular identifier or portion of an identifier of a token. For example, the wallet-internal token processor 314 can be integrated with or store a hash based on a particular semi-fungible token and a hash processor operable to generate a hash based on any semi-fungible token. The wallet-internal token processor 314 can generate a hash in response to detecting the presence of the semi-fungible token, and can determine whether the semi-fungible token is compatible with the smart contract control structure 210, in response generating the hash, by comparing the generated hash with the stored hash. The wallet-internal token processor 314 can include logic to detect a semi-fungible token passed to it, by, for example, an activation instruction from the mobile wallet system 170.

The wallet-internal token processor 314 can also detect the presence of a fungible token, and can determine whether the fungible token is compatible with the wallet-internal token processor 314. The wallet-internal token processor 314 can be configured to be compatible with a particular fungible token, or can be generated to be compatible with a particular fungible token. The wallet-internal token processor 314 can be configured to be compatible with a plurality of tokens having a particular characteristic, or can be generated to be compatible with a plurality of tokens having a particular characteristic. A particular characteristic can include, for example, a particular identifier or portion of an identifier of a token. For example, the wallet-internal token processor 314 can be integrated with or store a hash based on a particular fungible token and a hash processor operable to generate a hash based on any fungible token. The wallet-internal token processor 314 can generate a hash in response to detecting the presence of the fungible token, and can determine whether the fungible token is compatible with the smart contract control structure 210, in response generating the hash, by comparing the generated hash with the stored hash. The wallet-internal token processor 314 can include logic to detect a fungible token passed to it, by, for example, an activation instruction from the mobile wallet system 170.

The wallet-internal key processor 316 can detect the presence of the wallet key 214, and can extract one or more metrics, parameters, aspects, or values, or any combination thereof, from the wallet token 212, the cold storage object 184, and/or the restricted token 220. The wallet-internal key processor 316 can be configured to be compatible with the wallet token 212, the cold storage object 184, and/or the restricted token 220, the exchange interface 172, the token exchange system 104, the mobile wallet system 170, the cold storage ledger 182, and/or the ledger 161. Thus, the wallet-internal key processor 316 can provide a technical improvement of direct communication between the data processing system 102, the token exchange system 104, the mobile wallet system 170, the cold storage ledger 182, and the ledger 161.

The container 320 can include a security layer that restrict access to one or more of the tokens or cryptographic keys. The container 320 can include, for example, a security encapsulation that partially or completely encrypts one or more components of the container 320. The container 320 can include the wallet key(s) 214, the restricted token(s) 220, the internal key(s) 228, the cold storage object pointer(s) 330, and/or dynamic token exchange instrument(s) 332.

The container key processor 322 can detect the presence of a cryptographic key, and can determine whether the cryptographic key is compatible with the container 320. The container key processor 322 can obtain the cryptographic key from the wallet token 212, for example. For example, the wallet private key can be stored entirely within the wallet token 212. In another example, the container key processor 322 can obtain the cryptographic key from the restricted token 220 (stored within container 320 or received via the exchange interface 172). For example, the internal private key can be stored entirely within the restricted token 220. In another example, internal keys can be stored entirely within the internal key 228 (e.g., internal public key) to restrict output from the container 320 to the logical location corresponding to the internal key 228. For example, the cryptographic key can be stored partially within the internal key 228 and partially within the wallet token 212 or the restricted token 220, to restrict output from the container 320 to the logical location corresponding to the wallet key 214 or the internal key 228 by a distributed key. In another example, the cryptographic key can be stored partially within the internal key 228 (e.g., internal public key) and partially within the cold storage object 184 (e.g., internal private key), to restrict output from the container 320 to the logical location corresponding to the wallet key 214 or the internal key 228 by a distributed key.

In some arrangements, the container key processor 322 can detect the presence of a key (e.g., a private key or a public key (e.g., wallet or internal)), and can determine whether the key is compatible with the container 320. The container key processor 322 can obtain the key from one or more of a non-fungible token, a semi-fungible token, or a fungible token, and can transmit the token to the wallet-internal token processor 314. For example, the key can be stored entirely within the restricted token 220, the cold storage object 184, or the wallet token 212. For example, a private key can be stored entirely within the restricted token 220, to restrict output from the container 320 to the logical location corresponding to the restricted token 220.

The container output controller 324 can selectively transfer at least tokens and cryptographic keys from and to the container 320 based on determinations from the container key processor 322. For example, the container output controller 324 can transfer a token to the container 320 in response to a determination that the cryptographic key is compatible with the container key processor 322. The container 320 can include any number or combination of zero or more tokens and zero or more keys, and is not limited to the examples illustrated herein.

In some arrangements, the container output controller 324 can selectively transmit output from one or more of the restricted tokens 220 based on determinations from one or more of the internal key processor 318, the token authenticator processor 312, the wallet-internal token processor 314, or the wallet-internal key processor 316. For example, the container 320 can include a communication channel and a control structure to activate or deactivate the communication channel. The communication channel can communicatively couple the container 320 with a communication interface external to the smart contract control structure 210. For example, the container output controller 324 can activate the communication channel in response to a determination that the restricted token 220 and the wallet token 212 are both compatible with the smart contract control structure 210.

The wallet keys 214 (e.g., wallet public-private key pair) can correspond to a cryptographic key pair linked with a particular token account and the wallet token 212. For example, the wallet keys 214 can be used to “lock” and “unlock” the wallet token 212 on the mobile wallet system 170. In the above example, the mobile wallet system 170 can transmit the wallet token 212 and the wallet keys 214 when depositing the wallet token 212 at the data processing system 102. In some arrangements, an action can include transferring a token to a particular token account or smart contract. Transferring the token to the particular token account may include updating an entry in the ledger 161 but not broadcasting the token to the permission blockchain 260. In another example, a deposit action can include registering a token to a particular token account on the ledger 161 and broadcasting the token to the permission blockchain 260, or any combination thereof.

The internal keys 228 (e.g., internal public-private key pair) can correspond to a cryptographic key pair linked with a particular token account and the restricted token 220. For example, the internal keys 228 can be used to “lock” and “unlock” the restricted token 220 in the smart contract control structure 210. In the above example, the smart contract control structure 210 can transmit the restricted token 220 and the internal keys 228 when withdrawing the restricted token 220 at the data processing system 102. In some arrangements, an action can include transferring a token to a particular token account or smart contract.

The key processor 340 can generate, transfer, and modify various cryptographic keys. The key processor 340 can transfer one or more of the account key pairs (e.g., the wallet keys 214, the internal keys 228, etc.) to or from the container 320 of the smart contract control structure 210. For example, the key processor 340 can transfer a cryptographic key pair, a public key, a private key, a symmetric key, or any combination thereof, to or from the container 320 to indicate a change in control of a particular token account to the container 320. The key processor 340 can authenticate the container 320 to a particular token account in the ledger 161 based on a key of the container 320. For example, the key processor 340 can identify a token account associated with the internal keys 228 (e.g., internal public-private key pair). For example, the key processor 340 can transmit a hash based on the internal keys 228 to the mobile wallet system 170 associated with the token account, to authenticate the container 320 to the token account associated with the internal keys 228. The key processor 340 can generate a corresponding number of “internal keys” or “wallet keys” such as “public and private key pairs” that can control restrictions on output by the particular metadata object linked with the particular smart contract control structure 210 compatible with the particular token.

The token transfer processor 350 can transfer and modify various tokens. The token transfer processor 350 can include an API compatible with the permission blockchain 260. The token transfer processor 350 can selectively add, modify, and delete blocks (e.g., the blocks 262, etc.) from the permission blockchain 260. The token transfer processor 350 can add, modify, and delete blocks in accordance with restrictions or interfaces of the permission blockchain 260, and can add, modify, and delete blocks independently of the restrictions or interfaces of the permission blockchain 260 at any portion or index of the permission blockchain 260. The token transfer processor 350 can transfer the restricted token 220 to or from the container 320 of the smart contract control structure 210. For example, the NFT transfer processor 350 can transfer a token in response to an indication by the key processor 340 that a token account is linked with and authorized to a particular token account.

As used herein, an “on-us exchange” or “on-us transaction” is an exchange of a token between tokens accounts of the ledger 161. In some arrangements, the ledger 161 can be shared with other data processing systems external or remote to the data processing system 102. For example, the other data processing system may be another financial institution or provider of token exchanges. In some arrangements, the token transfer processor 350 can transfer and modify the ledger 161 based on receiving an exchange request between customers that have a token account with the ledger 161. Accordingly, the token transfer processor 350 can execute an on-us exchange by updating the ledger 161 to record the new ownership of the token being exchanged.

The wallet transfer processor 360 can transfer and modify various tokens. The wallet transfer processor 360 can include an API compatible with the mobile wallet system 170. The wallet transfer processor 360 can selectively deposit, withdraw, or update tokens stored on the mobile wallet system 170. The wallet transfer processor 360 can deposit, withdraw, or update tokens in accordance with restrictions or interfaces of the mobile wallet system 170, and can deposit, withdraw, or update tokens independently of the restrictions or interfaces of the mobile wallet system 170 at any portion or index. The wallet transfer processor 360 can transfer the restricted token 220 to or from the container 320 of the smart contract control structure 210. For example, the wallet transfer processor 360 can transfer a token in response to an indication by the key processor 340 that a withdrawal or deposit is requested by the mobile wallet system 170.

The token generator 370 can generate one or more tokens in accordance with a metadata object. For example, the token generator 370 can generate multiple tokens based on a number of new metadata objects or tokens indicated by an obtained token. For example, the token generator 370 can generate one or more tokens each including a link or a reference to a parent (or primary) token (e.g., the restricted token 220, etc.) to identify a source token corresponding to the token minted by the token generator 370 (e.g., for a physical asset or a digital asset). For example, the token generator 370 can generate one or more tokens each including a link or a reference to a token from which the new tokens are minted. Thus, the token generator 370 can provide a technical improvement of validating a minting of a token based on a parameter embedded in the token. The parameter can include a hash of the parent token or the token from which the new tokens are minted, for example. Generating a token and minting a token can be used interchangeably.

The token generator 370 can also generate one or more tokens in accordance with a token or a control structure. For example, the token generator 370 can generate multiple tokens based on a number of new metadata objects or tokens indicated by an obtained token, and linked with respective smart contract control structures. For example, the token generator 370 can generate one or more content tokens each linked with a particular smart contract control structure (e.g., the smart contract control structure 210, etc.) with which the respective token is compatible. The token generator 370 can modify and delete tokens linked with primary tokens or parent smart contract control structures, to update control of a partial transfer of metadata object control. For example, the token generator 370 can create a token controlling 25% of shares of a physical or digital asset, and modify a token originally controlling 100% of the asset to link with a smart contract control structure controlling 75% of the asset. The token generator 370 can make the modification in accordance with an example for a change in control of 25% of the asset controlled by the original token holder.

The metadata generator 380 can generate one or more metadata objects in accordance with a received request with third-party data (e.g., various data sources). For example, the metadata generator 380 can generate multiple tokens based on a number of new metadata objects indicated by a withdrawal, deposit, or update from the mobile wallet system 170, and linked with respective smart contract control structures (e.g., the smart contract control structure 210, etc.). For example, the metadata generator 380 can generate one or more metadata objects each linked with a particular smart contract control structure (e.g., the smart contract control structure 210) by which the respective metadata object is controlled. The metadata generator 380 can modify and delete metadata objects linked with tokens or the smart contract control structures 210.

The metadata generator 380 can modify a quantitative value corresponding to a token. For example, a quantitative value corresponding to a token can indicate a value of fiat currency or MBC currency. The metadata generator 380 can modify the quantitative value of the token based on a determined value (such as from off-chain data) to generate a scaled quantitative value. For example, a token having a quantitative value of 10,000 denominated in United States Dollar (USD) can be scaled based on a determined value of 0.1 to 1,000. The token scaler can perform any linear or non-linear transformation on a quantitative value, and is not limited to the example product transform discussed herein.

The dynamic token exchange processor 319 can detect the presence of the dynamic token exchange object 270 and can extract one or more attributes, parameters, aspects, or values, or any combination thereof, from the dynamic token exchange object 270. The dynamic token exchange transmission 301 can be responsive to an action by the exchange interface 172 to transmit the dynamic token exchange object 270 to the smart contract control structure 210 or the token transaction processor 250. The dynamic token exchange processor 319 can determine whether the dynamic token exchange object 270 is compatible with the dynamic token exchange processor 319. The dynamic token exchange processor 319 can be configured to be compatible with a particular dynamic token exchange object (e.g., the dynamic token exchange object 270, etc.), or can be generated to be compatible with the particular dynamic token exchange object. For example, the dynamic token exchange object 270 can link with the smart contract control structure 210 and receive an identification of or reference to a particular token. The dynamic token exchange processor 319 can then determine one or more characteristics or aspects of the token associated with the dynamic token exchange object 270, in response to receiving a transmission from or via the client system 103 including the dynamic token exchange object 270.

In some arrangements, the container key processor 322 can obtain and store one or more dynamic token exchange instruments 332 from the dynamic token exchange instrument printer 122 or the dynamic token exchange processor 319. Each of the dynamic token exchange instruments 332 can include a plurality of internal states that can be dynamically updated in real-time in response to collecting, receiving, and/or analyzing off-chain data associated with one or more assets represented by one or more tokens that collateralize the dynamic token exchange instrument 332. Upon generation of the dynamic token exchange instrument 332, the data processing system 102 (e.g., such as the dynamic token exchange instrument printer 122) can set initial internal states based on various features of one or more assets represented by one or more tokens that are collateralized. In some arrangements, the container key processor 322 can detect the presence of a key (e.g., a private key or a public key (e.g., wallet or internal)), and can determine whether the key is the dynamic token exchange instrument 332. The container key processor 322 can obtain the dynamic token exchange instrument 332 from the dynamic token exchange object 270 and/or from the various systems described herein. Additionally, the container key processor 322 can update the dynamic token exchange instruments 332 based on receiving off-chain data associated with assets represented by the restricted tokens 220.

FIG. 4 depicts an example token transaction processor (e.g., the token transaction processor 250, etc.), in accordance with present implementations. As illustrated by way of example in FIG. 4, the token transaction processor 250 can include at least a transaction controller 410, a cryptographic key generator 420, a smart contract generator 430, a dynamic valuation processor 440, a wallet transfer controller 450, a ledger interface processor 460, a cold storage ledger interface processor 470, and an exchange processor 480.

The transaction controller 410 can detect a presence of a token (e.g., fungible token, non-fungible token, partially-fungible token, etc.), and can transmit the token to a token processor (e.g., the token processor 310, etc.) compatible with that particular token. The transaction controller 410 can include the token authenticator processor 312, the wallet-internal token processor 314, the wallet-internal key processor 316, the internal key processor 318, and/or the dynamic token exchange processor 319. Each of the token authenticator processor 312, the wallet-internal token processor 314, and the wallet-internal key processor 316, the internal key processor 318, and the dynamic token exchange processor 319 are described in detail with reference to FIG. 3.

The cryptographic key generator 420 can generate and modify cryptographic keys in communication with the cryptographic key processor 120. For example, the cryptographic key generator 420 can include one or more asymmetric or symmetric key generators, and can generate public-private key pairs. For example, a public-private key pair can include a public key configured to encrypt (or decrypt) in accordance with a particular transform process. For example, a public-private key pair can include a private key configured to decrypt (or encrypt) in accordance with a particular transform process compatible with the public key. The cryptographic key generator 420 can link the public-private key pair with any individual object or component. The cryptographic key processor 120 can link any public key or private key corresponding to the public-private key pair with any individual object or component. For example, the cryptographic key generator 420 can generate a key compatible with or linked with a particular identifier corresponding to a particular device, user, customer, account, system, token, or any combination thereof.

In some arrangements, the cryptographic key generator 420 can generate and modify one or more cryptographic keys associated with particular tokens, digital wallets, or token accounts in communication with the smart contract engine 150. For example, the cryptographic key generator 420 can identify a public-private key pair corresponding to a wallet of an individual with a token account at the ledger 161. The cryptographic key generator 420 can modify one or more keys of the public-private key pair to link with a different token, digital wallet, or token account, or any combination thereof.

In various arrangements, the modifying cryptographic keys in communication with the cryptographic key processor 120 can include rotating keys of a token. Keys can be rotated (public-private key pair, or just the public key or private key individually) based on a key rotation parameter, where the key rotation parameter can indicate when or what keys to rotate of a token. For example, the key rotation parameter can include, but is not limited to, rotate the keys for each token every hour, day, week, rotate the keys in response to a detection of a threat (e.g., cyberthreat (e.g., a hack, fraudulent activity, data breach, suspected leak, etc.), etc.). The keys can be rotated based on a rotating key set of the key dataset 169. The rotating key set can be a set of public-private key pairs that can be used to lock and unlock a token. In some arrangements, the cryptographic key generator 420 can rotate or modify the token by transferring the token from the first internal address to a second internal address associated with the one of the plurality of internal public-private key in the rotating key set.

The smart contract generator 430 can generate and modify one or more smart contracts in communication with the smart contract engine 150. The smart contract generator 430 can execute instructions to generate or modify a cryptographic container (e.g., the container 320) or control structure (e.g., the smart contract control structure 210), to add or remove objects from the cryptographic container or the control structure, and to execute various processors linked with or embedded within the smart contract. The smart contract generator 430 can generate a smart contract based on criteria of a transfer of a token or modification to one or more token accounts (e.g., stored in the ledger 161) linked with corresponding cryptographic keys. For example, the smart contract generator 430 can generate the smart contract control structure 210 to include one or more of the restricted tokens 220, in response to determining that a request to transfer a token from the mobile wallet system 170 is valid in accordance with the token authenticator processor 312.

In some arrangements, the smart contract generator 430 can generate a smart contract and control structures of the smart contracts based on one or more of the wallet token 212 and the restricted tokens 220. The smart contract generator 430 can generate a smart contract compatible with the identified restricted tokens 220 and restricted to output. The smart contract generator 430 can generate a control structure or container embedded within a smart contract, and control structures of the control structure, based on one or more of the wallet token 212 and/or the restricted token 220. The smart contract generator 430 can also generate a smart contract control structure 210 encapsulating the identified restricted tokens 220 and restricted to output. The smart contract generator 430 can generate a private key compatible with a control structure, based on one or more of the metadata objects of the restricted token 220. The smart contract generator 430 can generate a private key to encrypt the encapsulation including the restricted token 220 and restricted to output. The smart contract generator 430 can be compatible with the permission blockchain 260. The smart contract control structure 210 can modify the permission blockchain 260 by the blockchain links 226. The blockchain links 226 can include an API compatible with the permission blockchain 260.

The dynamic valuation processor 440 can receive, generate, and modify a quantitative value of a token (e.g., the restricted token 220). The dynamic valuation processor 440 can receive a quantitative value of a token that corresponds to an amount of fiat currency, MBC currency, central bank digital currency (CBDC) currency, digital currency, for example. The dynamic valuation processor 440 can periodically update or receive an updated quantitative value in accordance with a predetermined schedule, a triggering event, or any combination thereof. The dynamic valuation processor 440 can modify an allocation of a token in response to a determination that a quantitative value of the token has changed. For example, the dynamic valuation processor 440 can determine that a value of a token has increased by 10% to $1,100, and can increase an allocation of the token to a cryptographic key pair corresponding to a financial institution that corresponds to an increased allocation of $100 to the cryptographic key pair corresponding to the financial institution. For example, the dynamic valuation processor 440 can determine that a value of a token has increased by 10% to $1,100, and can increase an allocation of the token to a cryptographic key pair corresponding to a buyer of the token that corresponds to an increased allocation of $100 to the cryptographic key pair corresponding to the buyer of the token. The dynamic valuation processor 440 can obtain, from a template of the smart contract corresponding to the token, one or more rules or instructions or attributes controlling modification of allocation of the token in response to a change in valuation of the token. Thus, the dynamic valuation processor 440 can provide a technical improvement of automatically and dynamically modifying allocations of a token to multiple cryptographic keys based on criteria of particular smart contracts that correspond to the token.

The wallet transfer controller 450 can instruct a container (e.g., the container 320) to execute a transfer of contents of the container or the smart contract control structure 210 to a container linked with the wallet key 214 or the internal key 228, in response to detecting or receiving an indication of a transfer event. The wallet transfer controller 450 can validate, by one or more of the internal key processor 318 or the wallet-internal key processor 316, that the container can be transferred. For example, the wallet transfer controller 450 can validate whether the container is located at the data processing system 102 by detecting presence of the internal key 228 (e.g., internal private key or internal public-private key pair). In response to detecting the presence of the internal key 228, the wallet transfer controller 450 can instruct a container to execute a transfer of contents of the container 320 or the smart contract control structure 210. In response to failing to detect the presence of the internal key 228, the wallet transfer controller 450 can instruct a container to block transfer of contents of the container 320 or the smart contract control structure 210. In response to detecting an absence of the internal key 228, the wallet transfer controller 450 can instruct a container to block transfer of contents of the container 320 or the smart contract control structure 210.

The ledger interface processor 460 can generate and modify token accounts in communication with the ledger 161. For example, the ledger interface processor 460 can update a token account based on a withdrawal or transfer of the restricted token 220. In another example, the ledger interface processor 460 can request a token account be created based on receiving an indication form the ledger 161 that a token account has not been created for the particular user or individual (e.g., associated with a unique identifier such as a SSN, first and last name, birthday, wallet public key). In various arrangements, the ledger interface processor 460 can generate and modify token accounts in communication with the ledger 161 when a token is transferred from a first token account to a second token account, or transferred from a wallet public address to an internal public address, or transferred from an internal public address to a wallet public address. In some arrangements, the ledger interface processor 460 may not update the permission blockchain 260 even though a token has been transferred. For example, when two token accounts are stored in the ledger 161 and the exchange is between the two accounts, the ledger interface processor 460 may query the ledger 161 and update or modify the token accounts to record the transfer from the first NFT account to the second NFT account stored at the ledger 161.

The cold storage ledger interface processor 470 can generate and modify one or more cold storage objects in communication with the cold storage processor 180. The cold storage ledger interface processor 470 can execute instructions to generate or modify a cold storage object (e.g., the cold storage object 184) or the cold storage ledger 182, to add, update, or remove the cold storage objects 184 from the cold storage ledger 182, and to execute various processors linked with the cold storage ledger 182. The cold storage ledger interface processor 470 can generate the cold storage object 184 based on receiving a deposit or withdrawal of a token or modification to one or more token accounts (stored in the ledger 161). Generation of the cold storage object 184 can include storing the wallet private key from the deposit of the token or an internal private key of the restricted token 220 and at least a portion of the metadata of the metadata object 224 of the token. In some arrangements, the portion of the metadata can be removed or deleted from the token such either the token can be update or reminted (with a new or updated link) without the portion of the metadata removed. The cold storage ledger interface processor 470 may determine the metadata removed is protected data of the token. The protected data can be sensitive data the token stored as metadata. The update or reminted token can then in turn include metadata that is unprotected (e.g., non-sensitive). Accordingly, the cold storage object 184 can be a data structure configured to store a private key (e.g., wallet or internal) and protected data of a token.

The cold storage ledger interface processor 470 can communicate with the cold storage processor 180 to store the cold storage object 184. Storing can include establishing an intermittent secure connection. Generating and using the cold storage object 184 improves data security and storage by obfuscating the metadata of the token and storing the protected data of the token in an offline storage that can only be accessed using an intermittent secure connection. Therefore, aspects of the present disclosure address problems in privacy by maintaining the privacy of protected data stored as metadata in tokens. By using the cold storage object 184, aspects of this technical solution can eliminate the exposure of protected data in metadata of tokens over the network and in the data processing system 102, which is a significant improvement over other protection or obfuscation architectures implemented on tokens. This not only protects data from compromise, but also protects private keys from exposure, which is a significant improvement to the security of tokens and public-private keys generally. Thus, the creation of the cold storage objects 184 and storage in the cold storage ledger 182 provides additional layers of security over the control structure security framework described herein.

The exchange processor 480 can process dynamic token exchange instrument exchanges in communication with the ledger 161, a payment network, and the client system (e.g., 103b). For example, the exchange processor 480 can update a token account based on the amount of the exchange (e.g., update current balance of the dynamic token exchange instrument) indicated in the dynamic token exchange object 270. In some arrangements, the exchange processor 480 is structured to process exchanges based on the received dynamic token exchange object 270 from a provider (e.g., the client system 103). For example, the received dynamic token exchange object 270 can include routing numbers of the buyer and seller, account numbers of the buyer and seller, desired payment rails (e.g., wire, ACH, Zelle®, RTP, and so on), and any other information to effectuate a transfer from a buyer to a seller (e.g., cryptocurrency public key, cryptocurrency public and private key pair, credit card, debit card, card network, and so on). For example, the information may include a desired payment method by the buyer, which the exchange processor 480 uses to identify an issuer, contact the issuer, provide a destination routing and account number to the issuer, an amount for the transaction, a desired timing of the transaction (e.g., within one-day, etc.), etc. for the issuer to transfer the funds and any applicable fees. Accordingly, the received dynamic token exchange object 270 can be utilized by the exchange processor 480 to process the exchanges from the buyer to the seller.

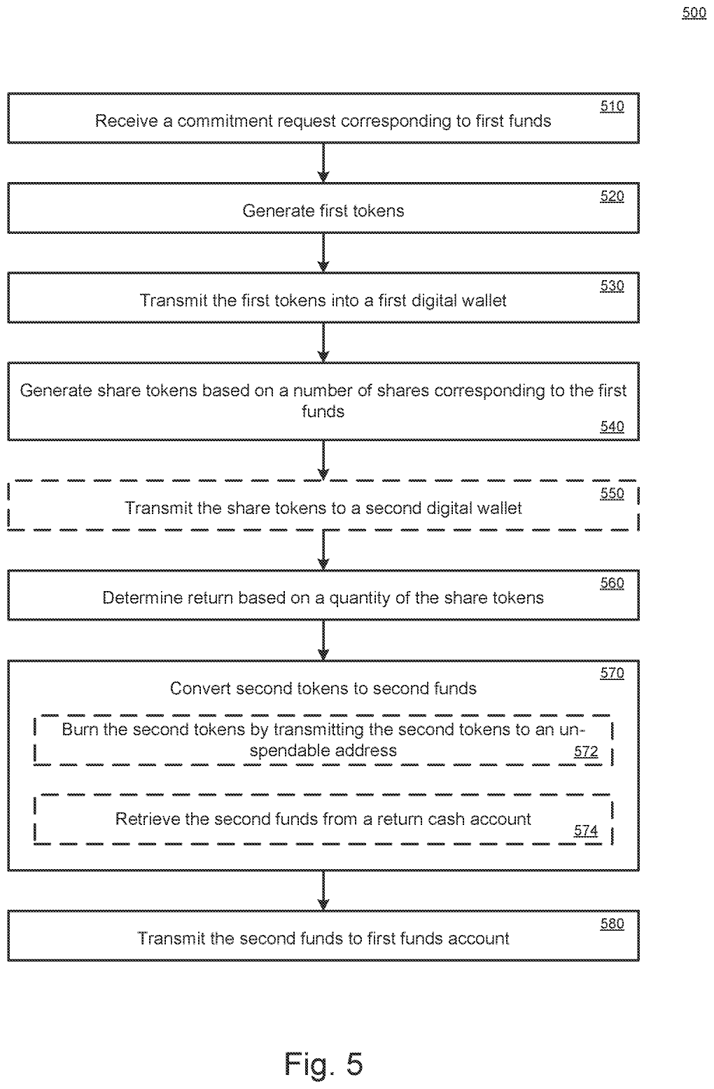

Referring now to FIG. 5, a flowchart for a method 500 to facilitate asset exchanges utilizing tokens (e.g., fungible tokens, semi-fungible tokens, non-fungible tokens, etc.) in accordance with present implementations. At least one of the example systems 100 and 200 or the example structures 300 and 400 can perform method 500 according to present implementations. It is to be appreciated that additional, fewer, or different operations (e.g., steps, substeps, etc.) than what is described herein may be performed depending on the particular arrangement. In some embodiments, some, or all operations of method 500 may be performed by one or more processors executing on one or more computing devices, systems, or servers. In various embodiments, each operation may be re-ordered, added, removed, or repeated.

In some arrangements, outputting the output of the metadata object can include outputting a fungible asset (e.g., a digital currency, a digital form of a fiat currency, a digital financial instrument for exchange, points associated with a rewards program, etc.) or a non-fungible asset (e.g., NFT, real estate, domain names, event tickets, in-game items like avatars, etc.) to a remote device. In some arrangements, the off-chain data can be received via a data channel between one or more processors of the data processing system 102 and another third-party system (e.g., client system 103 or third-party device). Thus, the off-chain data can include, but is not limited to, financial status of businesses via transaction history (e.g., sales, costs of goods, costs of maintenance, payroll etc.), applications for loans, financial status of a fund (e.g., money to be withdrawn from fund, money to be deposited into fund, etc.), and the like. By using the tokens with particular control structures, aspects of this technical solution can eliminate the exposure of sensitive data within a supply chain and in a computer networked environments, which is a significant improvement over other asset and data protection architectures. This not only protects sensitive assets and other data from compromise, but also protects entities from exposure, which is a significant improvement to the security of computing systems.

At block 510, the one or more processors can receive a commitment request corresponding to first funds. The commitment request can be received from a first computing system (e.g., the client system 103, the third-party device, another system or device connected to network 101, etc.). The commitment request can include information such as, but not limited to, an origin funds account (e.g., a cash account, a digital cash account, a fiat currency account, a cryptocurrency account, etc.) associated with the first computing system, a receiving funds account associated with the one or more processors, asset information (e.g., fund currency, fund amount, etc.), images and videos of the asset, asset identifier, user information (e.g., blockchain address, wallet address, public and private key pair, public key, private key, account information, location information, exchange history), and so on. Receiving may include the one or more processors receiving a confirmation of, or confirming, a transfer of the first funds from the origin funds account to the receiving funds account. The first funds may include fiat currency, MBC currency, central bank digital currency (CBDC) currency, cryptocurrency, digital currency, stocks, bonds, loan, deed, etc.).

In some arrangements, the commitment request is received by the one or more processors from the first computing system, in response to determining that the user of the first computing system initiated an exchange for funds. The one or more processors may determine that the customer initiated the exchange based on off-chain data, receiving a notification (e.g., message, email, call, etc.) regarding the exchange, receiving documents associated with the exchange (e.g., price quotes, contracts, agreements terms, deadlines, discussions, proposals, etc.), or the like.

At block 520, the one or more processors generate first tokens by tokenizing the first funds. In some arrangements, the one or more processors generate the first tokens in response to receiving the first funds. In some arrangements, tokenizing the first funds includes generating a funds metadata object that includes metadata of the first funds, and generating, based on the funds metadata object, the first tokens, where each of the first tokens includes a link to the funds metadata object. The one or more processors can receive, collect, or obtain metadata of an asset (e.g., the first funds, etc.) including, but not limited to, video, a code, audio, text, any media or digital representation, public and private key pair, executable programs, or any combination thereof of the asset.

At block 530, the one or more processors transmit the first tokens into a first digital wallet. The first digital wallet may be associated with the one or more processors such that the first digital wallet is accessible by the one or more processors. In some arrangements, the first digital wallet includes a tokenized fund. The tokenized fund may include the first tokens received from the first computing system and any other funds received by the first computing system or other computing systems (e.g., the client system 103, etc.). The tokenized fund may provide the advantage of being able to transfer funds, more particularly representation of funds (e.g., the first tokens, etc.), in short amounts of time, or real-time, removing the need of long processing time associated with transfer of funds between funds accounts.

At block 540, the one or more processors generate share tokens based on a number of shares corresponding to the first funds. The share tokens may be a representation of the number of shares corresponding to the first funds received from the first computing system. In some arrangements, the calculation of the number of shares may be based on a total amount of funds corresponding to an amount of tokens (e.g., first tokens, etc.) in the first digital wallet. For example, the number of shares may be proportional to an amount of the first funds relative to a total amount of funds in the funds account. In another example, the number of shares may be proportional to an amount of the first tokens relative to the amount of tokens in the first digital wallet. In some examples, calculation may be executed by the one or more processors based on the amount of tokens in the first digital wallet at the time and date at which the commitment request was received by the one or more processors. In some arrangements, the calculation of the number of shares corresponds to an amount included in the commitment request. In some arrangements, the calculation of the number of shares is based on amount agreed by a user associated with the first computing system (e.g., the customer, etc.) and an entity associated with the data processing system 102 (e.g., a financial institution, etc.).

At block 550, the one or more processors may transmit the share tokens to a second digital wallet associated with the first computing system. In some arrangements, the share tokens are NFTs (e.g., share NFTs, etc.) that include shareholder identifiers that identify the user of the first computing system. In further arrangements, the first computing system may need to transfer a message to the data processing system 102 that includes a user identifier and the share tokens in order to authenticate the user and process and exchange of digital assets. For example, the user identifier provided in the message and the shareholder identifier in the share NFTs may include a digital address (e.g., an address of the second digital wallet), biometric data, etc., associated with the user. In some examples, the biometric data provided in the message may be retrieved from the user in real-time using a fingerprint device (e.g., a fingerprint reader, a smartphone with a fingerprint reader, etc.). The one or more processors may authenticate the user by comparing and matching the biometric data in the message to a stored biometric data in the share NFT. Therefore, the share NFTs may provide a security benefit to the user such that they provide lesser value or no value to a fraudulent user (e.g., a hacker, etc.) who may steal them. In some arrangements, the share tokens are semi-fungible tokens or fungible tokens.

At block 560, the one or more processors determine return based on a quantity of the share tokens. The return may be determined based on a value gained from utilizing the first funds received from the first computing system. For example, the first funds may be utilized by an entity associated with the data processing system 102 to financially back a loan provided to a business party. In this example, the value gained may be an amount of interest received by the entity associated with the data processing system 102 from the business party for providing the loan. The return for the user of the first computing system may be calculated as a proportion of the value gained (e.g., the interest), which may correspond to a ratio of the quantity of share tokens associated with the user of the first computing system relative to a total number of share tokens created by the data processing system 102 (e.g., share tokens of other users, etc.). In some examples in which a portion of the share tokens created by the data processing system 102 become inactive (e.g., due to a participating user withdrawing invested funds, etc.), the total number of share tokens utilized to calculate the return associated with the user of the first computing system may represent a total number of active share tokens.

At block 570, the one or more processors convert, based on the return (e.g., determined at the block 560), second tokens to second funds. In some arrangements, where the value gained includes the interest received from the business party, the one or more processors may generate second tokens (e.g., interest tokens, etc.) by tokenizing the received interest (e.g., interest funds, etc.). In some examples, the one or more processors may store the second tokens in the first digital wallet or a different digital wallet (e.g., a gained digital wallet, an interest digital wallet, etc.). In these arrangements, at the block 570, the one or more processors may convert, based on the return, at least a portion of the second tokens to the second funds to distribute to the user as the return. The second funds may include similar implementations to those discussed above with respect to the first funds.

The block 570 may include sub-blocks 572 and 574. At sub-block 572, the one or more processors may burn the second tokens (or the at least the portion of the second tokens, etc.) by transmitting the second tokens to an un-spendable (e.g., eater, null, inaccessible, etc.) address, where no user and/or device has access to the private key of that particular un-spendable address. Accordingly, the second tokens would be un-spendable and un-exchangeable. At sub-block 574, the one or more processors retrieve the second funds from a return funds account. In some arrangements, the return funds account may store the interest, or at least a portion of the interest, received by the entity associated with the data processing system 102 from the business party.

At block 580, the one or more processors transmit the second funds to a first funds account associated with the user of the first computing system. In some arrangements, the one or more processors transmit the second funds to the first funds account on a day of the month that corresponds to a day of the month the one or more processors received the commitment request from the first computing system. For example, the one or more processors may transmit the second funds to the first funds account on Mar. 15, 2015, in response to receiving the commitment request from the first computing system on Feb. 15, 2015. In some arrangements, the one or more processors transmit the second funds to the first funds account on a day of the month that corresponds to a day of the month the one or more processors received the first funds from the first computing system. For example, the one or more processors may transmit the second funds to the first funds account on Mar. 15, 2015, in response to receiving the first funds at a funds account from the first computing system on Feb. 15, 2015. In some arrangements, the one or more processors transmit the second funds to the first funds account shortly after, or in real-time to, receiving the value gained. For example, the one or more processors may transmit the second funds to the first funds account shortly after, or in real-time to, receiving the interest at the return funds account from the business party.

In some arrangements, the one or more processors are configured to receive a servicing request corresponding to a loan. The servicing request may be received from the business party (e.g., the client system 103, the third-party device, another system or device connected to network 101, etc.). The servicing request can include information such as, but not limited to, an origin funds account (e.g., a cash account, a digital cash account, etc.) associated with the business party or a business computing system of the business party, a receiving funds account associated with the one or more processors, asset information (e.g., fund currency, fund amount, etc.), images and videos of the asset, asset identifier, user information associated with the business party (e.g., blockchain address, wallet address, public and private key pair, public key, private key, account information, location information, exchange history), and so on. In some arrangements, the commitment request is received by the one or more processors from the business computing system, in response to determining that the business party initiated an exchange for funds. The one or more processors may determine that the business party initiated the exchange based on off-chain data, receiving a notification (e.g., message, email, call, etc.) regarding the exchange, receiving documents associated with the exchange (e.g., price quotes, contracts, agreements terms, deadlines, discussions, proposals, etc.), or the like.

In some arrangements, the one or more processors are further configured to, in response to receiving the servicing request, generate a loan token by tokenizing the loan. The loan token may correspond to a payment schedule. The payment schedule may include guidelines for a payment amount and a payment due date. The payment schedule may further include guidelines for late payment fees that would be triggered and added to a total payment amount in case the payment amount is not paid, partly paid, and/or fully paid by the payment due date. In some arrangements, the one or more processors are further configured to transmit the loan token to the first digital wallet associated with the one or more processors.

The loan token may include a link to a loan metadata object that includes metadata of the loan and one or more outputting attributes for outputting funds associated with the loan from a business funds account associated with the business party to an entity funds account associated with the data processing system 102 (e.g., the one or more processors, etc.). The one or more outputting attributes may also related to outputting assets (e.g., digital assets, physical assets, etc.) associated with the loan as collateral, for example, from the business funds account, a business digital address, a business physical address, etc. associated with the business party to the entity funds account, an entity digital address (e.g., the first digital wallet, etc.), an entity physical address, etc. associated with the data processing system 102 (e.g., the one or more processors, etc.). The entity and the data processing system 102 may have access (e.g., temporary access, permanent access, etc.) to the business funds account, the business digital address, and the business physical address. The loan metadata object may be encapsulated within a control structure that restricts transfer of the funds and/or assets from the business funds account, the business digital address, the business physical address, etc. to the entity funds account, the entity digital address, the entity physical address, etc.

The one or more processors may continuously monitor the loan based on collecting off-chain data from one or more off-chain data feeds. For example, the one or more off-chain data feeds may correspond to the payment schedule, transaction history associated with the business party, and the like. The one or more processors may detect, by the control structure of the loan token, that at least one outputting attribute of the one or more outputting attributes is satisfied based on the off-chain data. The one or more processors may, in response to detecting the at least one outputting attribute is satisfied, transfer the funds and/or assets from the business funds account, the business digital address, the business physical address, etc. to the entity funds account, the entity digital address, the entity physical address, etc. In some arrangements, the one or more processors may transfer the assets from the business digital address or the business physical address to the entity digital address or the entity physical address, in response to failing to transfer funds from the business funds account to the entity funds account. For example, the one or more processors may fail to transfer the funds from the business funds account to the entity funds account due to insufficient funds in the business funds account.

Referring to a plurality of attributes (e.g., the one or more outputting attributes, etc.) in more detail, each attribute can include or consist of a key value pair, where the key is the rule that can be satisfied and the value is the output associated with the token and/or the metadata object associated with the token. The plurality of attributes may include multiple types of attributes. In some arrangements, the plurality of attributes include a plurality of outputting attributes for outputting an output of the metadata object. For example, an outputting attribute of the plurality of outputting attributes could be a destination attribute where the key could be a destination on the proposed route and the value could be a destination for outputting (e.g., wallet address, blockchain address) the output of the metadata object upon satisfying the rule. In another example, the outputting attribute could be a timing attribute where the key could be a time the asset is delivered or arrives at a particular address (e.g., digital address, physical address, etc.) and the value could be a digital currency value and a destination for transferring the digital currency (e.g., the output of the metadata object) upon satisfying the rule. In yet another example, the outputting attribute could be a quality attribute where the key could be an image or video of an asset (e.g., cash, etc.) and the value could the destination for outputting the output of the metadata object upon satisfying the rule. The metadata control structures can analyze off-chain data and the attributes to determine if the value of the attribute is satisfied, and in turn output based on the key of the attribute.

As used herein, a “public and private key pair” (e.g., key pairs, verification and signing key pair, etc.) can be generated based on a cryptographic function (e.g., symmetric-key algorithms (such as DES, AES), asymmetric-key algorithms (Ed25519 signing, ECC), public-key algorithms (such as RSA), and so on) and be stored on a blockchain (e.g., the blockchain storage 168) or storage (e.g., the token storage 162). In some arrangements, each blockchain can maintain (e.g., store and allow access to keys) a key dataset such that the token may be associated with a public and private key pair stored in the key dataset. Each public and private key pair can be shared amongst multiple tokens or can be unique to each digital asset on the ledger. In particular, the public key and the private key of the public and private key pairs can be mathematically related based on a mathematical algorithm, such that a private key be used to encrypt data (e.g., such as an asset) and the public key can be used to decrypt the data, or vice versa. In some arrangements, the digital asset may be configured based on a standardized language (e.g., key-value pairs, dictionaries, tables, mappings, pairings) for interpreting data (e.g., metadata objects).

In some arrangements, upon identifying or generating public and private keys of the token, the one or more processors can sign the token using one or more identified private keys and transmit the token or outputs with a public key to the exchange interface 172. In particular, signing using the private key can include hashing (e.g., SHA1, MD5, etc.) the token and verifying using the public key can include decrypting the token using the public key to verify the digital signature came from the particular private key. In some arrangements, the keys may be symmetric (e.g., use the same key to sign/verify) or asymmetric (e.g., use different keys to sign/verify). For example, an algorithm (e.g., such as a hash algorithm) can be applied to a private key to generate a public key. Accordingly, public keys can be a cryptographic code that allows users and system described herein to receive the token and verify the token.

Additionally, the images and videos of the asset can be analyzed and/or interpolated by the one or more processors to create a model of the asset. The model can designate a plurality of metadata areas within the image or video of the asset. The model can be trained to identify matches between the asset and a captured image or video at a future time (e.g., when the asset arrives at an attribute of the proposed route). In particular, matches can be between metadata areas of the asset and the metadata areas of the captured image.

The control structure may be stored as at least one of a smart contract, or in a block on an internal ledger. In some arrangements, the control structure can be generated based on the attributes that are executable to restrict output of one or more particular metadata objects. In particular, the one or more processors can obtain the attributes and generate a control structure corresponding to the attributes. For example, the one or more processors can generate a control structure to encapsulate the metadata object including the metadata of the exchange. The control structure can restrict access to the metadata object within the control structure, by an encapsulation layer that, for example, encrypts the metadata object within the control structure with a common encryption scheme. The encapsulation layer can control output of the metadata object within the control structure by decrypting the metadata object according to the common encryption scheme.

As used herein, a “smart contract control structure,” “metadata control structure,” and “control structure” may be a computer program (also known as a program, software, software application, script, or code) configured to combine one or more attributes of the exchange together to create a single control structure for the metadata object. In some arrangements, the one or more processors can implement and execute a control structure to output, append, or update the metadata object of the token to include one or more metadata, attributes, and conditions (e.g., smart contracts), fields, a value, and so on. The control structure can be written in any form of programming language, including compiled or interpreted languages, and/or declarative or procedural languages, and it can be deployed in any form, including as a stand-alone program or as a circuit, component, subroutine, object, or other unit suitable for use in a computing environment. A metadata object may, but need not, correspond to a file in a file system. A metadata object can be stored in a portion of a file that holds other programs or data (e.g., one or more scripts stored in a markup language document), in a single file dedicated to the token in question, or in multiple coordinated files (e.g., files that store one or more subsystems, sub-programs, or portions of code). A control structure can be deployed to be executed on one computer or on multiple computers that are located at one site or distributed across multiple sites and interconnected by a communication network. The processes and logic flows described in this specification can be performed by one or more programmable processors executing one or more control structures (or computer programs) to perform actions by operating on input data (e.g., off-chain data, provenance requests, etc.).

As used herein, the phrase “smart contract” generally refers to a self-executing code (e.g., in a ledger network or other system) that executes when a set of conditions that have been agreed upon by the parties of the smart contract are met. The systems, methods, and apparatuses disclosed herein can also be used for a plurality of types of assets, such as but not limited to commodities, common shares, options, dollar bills, fiat currency, digital currency, deeds, leases, wills, other exchanges, non-smart contracts, traditional legal contracts, financial disbursements, taxes, and other types of non-fungible or fungible assets parties use and exchange. Parties to the smart contract for tokens or other types of non-fungible or fungible assets may be individuals, companies, organizations, entities, providers, and so on.

In some arrangements, the one or more processors are configured to receive a loan update request corresponding to third funds and an updated payment schedule. The one or more processors may receive the loan update request from the business computing system. In some examples, the third funds may correspond to the payment amount associated with the loan. The third funds may be transferred from the business funds account to the entity funds account. The payment amount may be for a particular time period (e.g., a month, a year, etc.) or it may be for a total amount of the loan. In some examples, the updated payment schedule corresponds to a new payment schedule generated based on the payment amount corresponding to the third funds. For example, if the payment schedule (e.g., original payment schedule) included $1,000 for a first month and $1,000 for a second month and the third funds correspond to a $1,000 paid in the first month, the updated payment schedule includes only the $1,000 for the second month (e.g., does not include the $1,000 for the first month since it was paid via the third funds). The third funds may include similar implementations to those discussed above with respect to the first funds and/or the second funds.

The one or more processors may be further configured to generate third tokens by tokenizing the third funds. The one or more processors may transmit the third tokens to the first digital wallet and associated with the one or more processors. In some arrangements, the one or more processors may determine a principal amount of the third funds and an interest amount of the third funds. In some examples, the one or more processors may transmit a first amount of the third tokens corresponding to the principal amount of the third funds to the first digital wallet, and a second amount of the third tokens corresponding to the interest amount of the third funds to the interest digital wallet associated with the one or more processors. In these examples, the third tokens in the interest digital wallet may be equivalent to the second tokens (e.g., the interest tokens, etc.).

The one or more processors may further modify the loan token to include the updated payment schedule. In some arrangements, modifying the loan token includes the one or more processors burning the loan token. Burning the loan token may include transmitting the loan token to the un-spendable address, where no user and/or device has access to the private key of that particular un-spendable address. Accordingly, the loan token would be un-spendable and un-exchangeable. Modifying the loan may further include the one or more processors generating a new loan token corresponding to the updated payment schedule. The new loan token may further correspond to the payment schedule (e.g., the original payment schedule). Modifying the loan may further include transmitting the new loan token to the first digital wallet associated with the one or more processors (e.g., as a replacement to the loan token, etc.).

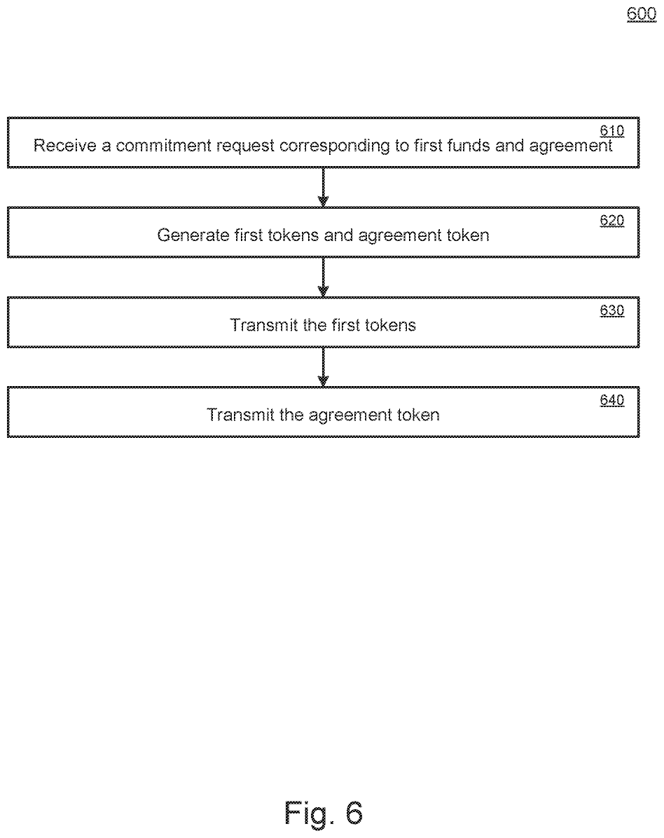

Referring now to FIG. 6, a flowchart for a method 600 to facilitate asset exchanges utilizing tokens (e.g., fungible tokens, semi-fungible tokens, non-fungible tokens, etc.) in accordance with present implementations. At least one of the example systems 100 and 200 or the example structures 300 and 400 can perform method 600 according to present implementations. It is to be appreciated that additional, fewer, or different operations (e.g., steps, substeps, etc.) than what is described herein may be performed depending on the particular arrangement. In some embodiments, some, or all operations of method 600 may be performed by one or more processors executing on one or more computing devices, systems, or servers. In various embodiments, each operation may be re-ordered, added, removed, or repeated.

At block 610, the one or more processors can receive a commitment request corresponding to first funds and an agreement. The commitment request can be received from the first computing system (e.g., the client system 103, the third-party device, another system or device connected to network 101, etc.). The commitment request can include information such as, but not limited to, the origin funds account associated with the first computing system, a receiving funds account associated with the one or more processors, asset information, images and videos of the asset, asset identifier, user information, and so on. Receiving may include the one or more processors receiving a confirmation of, or confirming, a transfer of the first funds from the origin funds account to the receiving funds account and a transfer of the agreement from an origin digital or physical address to a receiving digital or physical address. In some arrangements, the agreement is a representation of a commitment of the user of the first computing system to provide the first funds. In some arrangements, the agreement is a representation of a commitment of the user of the first computing system to provide additional funds in addition to the first funds. The agreement may include a legal agreement (e.g., legal contract, etc.).

At block 620, in response to receiving the commitment request, the one or more processors can generate first tokens by tokenizing the first funds and generate an agreement token by tokenizing the agreement. In some arrangements, tokenizing the first funds includes generating a funds metadata object that includes metadata of the first funds, and generating, based on the funds metadata object, the first tokens that include a link to the funds metadata object. In some arrangements, tokenizing the agreement includes generating an agreement metadata object that includes metadata of the agreement, and generating, based on the agreement metadata object, the agreement token that includes a link to the agreement metadata object. The metadata object of the agreement may include a text document associated with the agreement (e.g., a text document of the agreement, text signatures of the parties bounded by the agreement, time at which the agreement was signed by each party or all parties, etc.), a digital image associated with agreement (e.g., an image of the agreement, an image of the parties bounded by the agreement accepting the agreement (e.g., signing, shaking hands, etc.), etc.), a video associated with the agreement (e.g., a video of the agreement, a video of the assets associated with the agreement, a video of the parties bounded by the agreement accepting the agreement, etc.), or the like.

At block 630, the one or more processors transmit the first tokens to a first digital wallet. As discussed previously, the first digital wallet may be associated with the one or more processors such that the first digital wallet is accessible by the one or more processors. In some arrangements, in response to receiving a conversion request associated with the first tokens, the one or more processors convert the first tokens into fiat funds and transfer the fiat funds into the fund account (e.g., the entity fund account, etc.). The fund account may be associated with the one or more processors such that the fund account is accessible by the one or more processors.

At block 640, the one or more processors transmit the agreement token to the second digital wallet associated with the first computing system. In some arrangements, the agreement token is an NFT (e.g., agreement NFT) that includes signer identifiers that identify the user of the first computing system. In further arrangements, the first computing system may need to transfer a message to the data processing system 102 that includes a user identifier and the agreement token in order to authenticate the user and process and exchange of digital assets. For example, the user identifier provided in the message and the signer identifier in the agreement NFT may include a digital address (e.g., an address of the second digital wallet), biometric data, etc., associated with the user. In some examples, the biometric data provided in the message may be retrieved from the user in real-time using the fingerprint device. The one or more processors may authenticate the user by comparing and matching the biometric data in the message to a stored biometric data in the agreement NFT. Therefore, the agreement NFT may provide a security benefit to the user such that they provide lesser value or no value to the fraudulent user who may steal it. In some arrangements, the agreement token is a semi-fungible token or a fungible token.

In some arrangements, the one or more processors receive a loan tokenization request corresponding to a loan. In response to receiving the loan tokenization request, the one or more processors may generate a loan token (e.g., the loan token described herein) by tokenizing the loan. The one or more processors may further transmit the loan token to the first digital wallet. In some arrangements, the one or more processors generate, based on servicing tape loan data associated with loan, a data report (e.g., a yield report, etc.) that includes a loan yield. The servicing tape loan data and/or the data report my include a user identifier (e.g., a customer ID associated with a particular customer, etc.), a receivable identifier (e.g., a receivable ID associated with a particular receivable, etc.), repayment history (e.g., repayment start date, last payment date (e.g., date the loan will be paid in full, etc.), etc.), status (e.g., delinquent, current, default, etc.), principal information (e.g., original principal balance, outstanding principal balance, etc.), outstanding balance, interest rate, credit score of borrower (e.g., FICO score, etc.), loan origination date, information that may impact repayment of the loan, borrower inquiries regarding paying off loan early, notifications to servicer regarding borrower filing for bankruptcy, disclosures (i.e., required by law or regulation, etc.), or the like. The one or more processors may tokenize the servicing tape loan data. In some arrangements, the one or more processors receive second funds (e.g., interest, etc.) based on the loan yield. The one or more processors may generate second tokens (e.g., the interest tokens, etc.) by tokenizing the second funds. The one or more processors may further transfer the second tokens to the second digital wallet associated with the user of the first computing system. In some arrangements, the one or more processors, in response to receiving a conversion request associated with the second tokens, convert the second tokens into fiat funds and transfer the fiat funds into the first funds account associated with the user of the first computing system.

In some arrangements, the one or more processors are configured to receive a payment indication associated with third funds. The payment indication may indicate a confirmation of a payment amount being received at the funds account (e.g., the entity funds account, etc.) associated with the one or more processors. In response to receiving the payment indication, the one or more processors may generate third tokens by tokenizing the third funds. The one or more processors may transfer the third tokens to the first digital wallet that is associated with and accessible by the one or more processors. The one or more processors may determine, based on the servicing tape loan data and the third funds, whether the loan is paid off. In response to determining the loan is paid off, the one or more processors burn the loan token. Burning the loan token may include transmitting the loan token to the un-spendable address, where no user and/or device has access to the private key of that particular un-spendable address. Accordingly, the loan token would be un-spendable and un-exchangeable. The one or more processors may, in response to receiving a conversion request associated with the third funds, convert the third tokens into fiat funds and transfer the fiat funds into the funds account associated with the one or more processors.

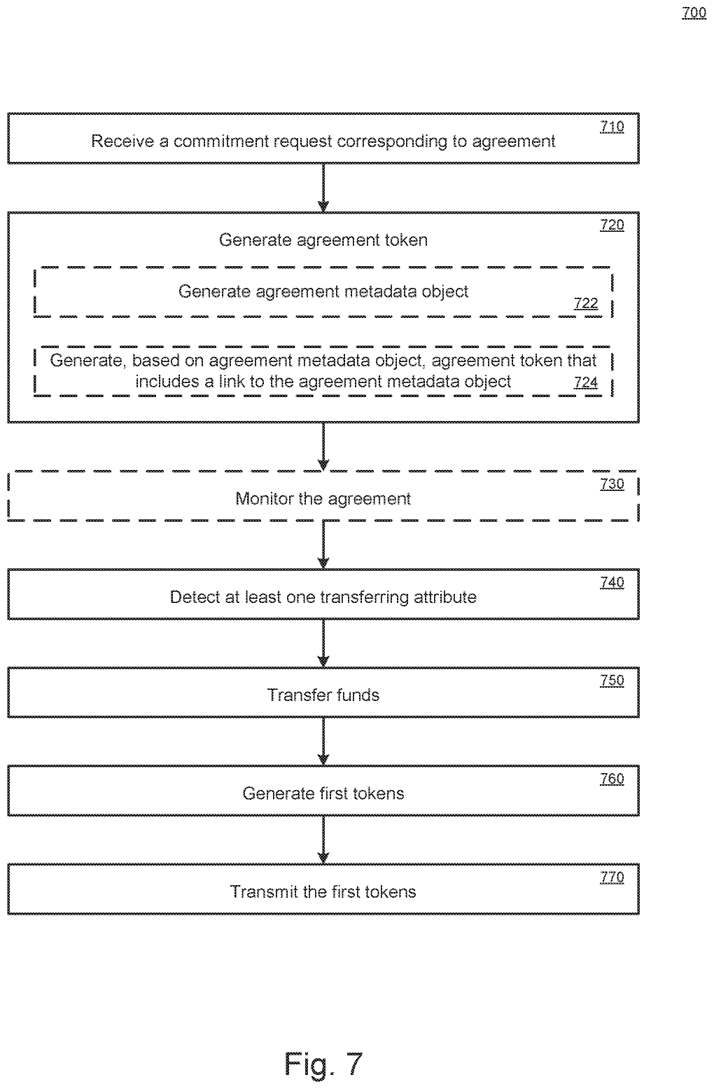

Referring now to FIG. 7, a flowchart for a method 700 to facilitate asset exchanges utilizing tokens (e.g., fungible tokens, semi-fungible tokens, non-fungible tokens, etc.) in accordance with present implementations. At least one of the example systems 100 and 200 or the example structures 300 and 400 can perform method 700 according to present implementations. It is to be appreciated that additional, fewer, or different operations (e.g., steps, substeps, etc.) than what is described herein may be performed depending on the particular arrangement. In some embodiments, some, or all operations of method 700 may be performed by one or more processors executing on one or more computing devices, systems, or servers. In various embodiments, each operation may be re-ordered, added, removed, or repeated.

At block 710, the one or more processors can receive a commitment request corresponding to an agreement (e.g., the agreement disclosed herein). The commitment request can be received from the first computing system (e.g., the client system 103, the third-party device, another system or device connected to network 101, etc.). The commitment request can include information such as, but not limited to, the origin digital wallet associated with the first computing system, a receiving digital wallet associated with the one or more processors, asset information, images and videos of the asset, asset identifier, user information, and so on. Receiving may include the one or more processors receiving a confirmation of, or confirming a transfer of the agreement from an origin digital or physical address to a receiving digital or physical address.

At block 720, in response to receiving the commitment request, the one or more processors can generate an agreement token by tokenizing the agreement. The block 720 may include sub-blocks 722 and 724. At sub-block 722, the one or more processors may generate an agreement metadata object that includes metadata of the agreement and one or more transferring attributes for transferring funds (e.g., the first funds, etc.) associated with the agreement from the first funds account (e.g., user funds account) associated with the first computing system to the entity funds account (e.g., the funds account, etc.) associated with the data processing system 102 (e.g., the one or more processors, etc.). At sub-block 724, the one or more processors may generate, based on the agreement metadata object, an agreement token that includes a link to the agreement metadata object and encapsulated within a control structure that restricts transfer of the first funds from the first funds account to the entity funds account.

At block 730, the one or more processors can continuously monitor the agreement based on collecting off-chain data from one or more off-chain data feeds. For example, the one or more off-chain data feeds may correspond to the payment schedule, transaction history associated with the business party, and the like.

At block 740, the one or more processors may detect, based on the control structure of the agreement token, at least one transferring attribute of the one or more transferring attributes is satisfied based on the off-chain data. For example, the at least one transferring attribute may include a requested funds amount (e.g., a requested loan amount, etc.) requested from the entity funds account being larger than an amount of funds available in the entity funds account, such that the first funds from the user funds account are needed in the entity funds account to fulfill, or assist in fulfilling, the requested loan amount.

At block 750, in response to detecting the at least one transferring attribute is satisfied, the one or more processors can transfer the first funds from the user funds account into the entity funds account. The one or more processors may have access (e.g., temporary access, permanent access, etc.) to the user funds account.

At block 760, in response to transferring the first funds, the one or more processors generate first tokens (e.g., the first tokens disclosed herein) by tokenizing the first funds. In some arrangements, tokenizing the first funds includes generating a funds metadata object that includes metadata of the first funds, and generating, based on the funds metadata object, the first tokens, where each of the first tokens includes a link to the funds metadata object. At block 770, the one or more processors transmit the first tokens into the first digital wallet that is associated with and accessible by the one or more processors. In some arrangements, the one or more processors may, in response to receiving a conversion request associated with the first tokens, convert the first tokens into fiat funds and transfer the fiat funds into the funds account that is associated with the one or more processors.

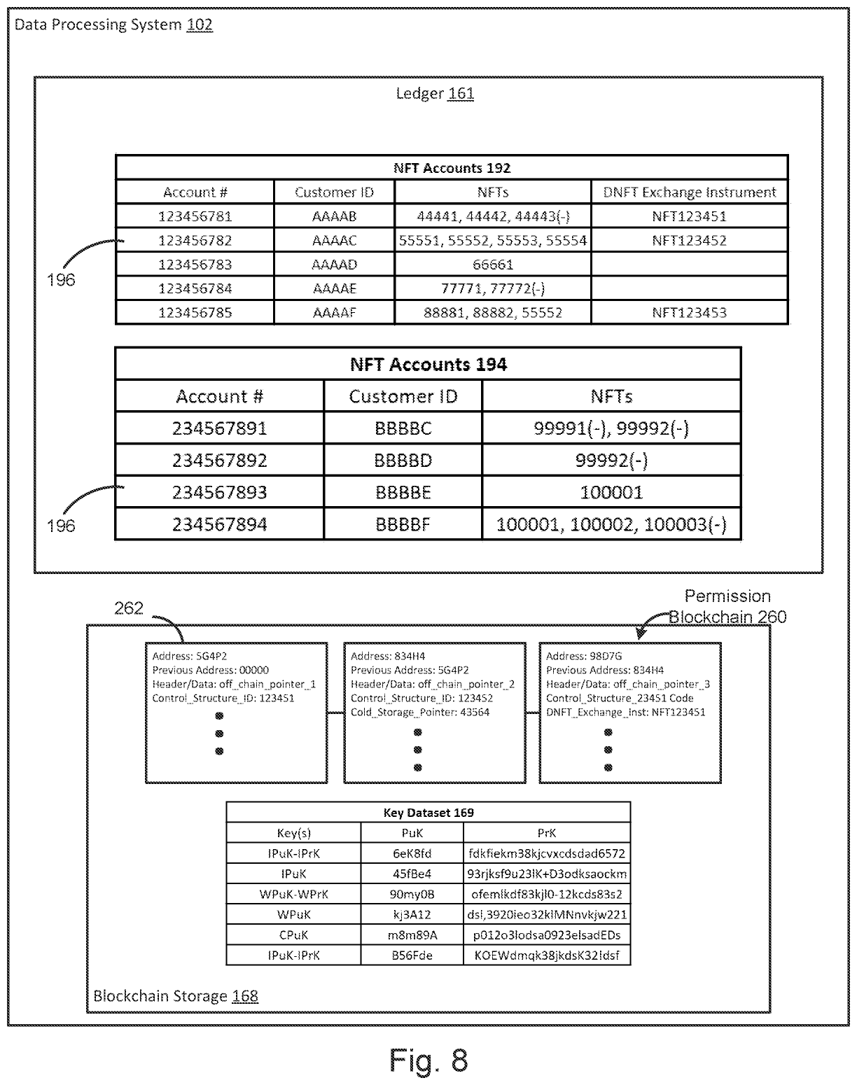

Referring now to FIG. 8, a detailed representation of the ledger 161 and the blockchain storage 168 within the data processing system 102, is shown according to an example arrangement. Token exchange customers (e.g., withdraw, deposit) can be NFT account holders (sometimes referred to herein as “token account holders”) with the data processing system 102. In other arrangements, and as described in further detail below, the token exchange customers may be registered with the data processing system 102 prior to engaging in exchanges using the data processing system 102. For example, a deposit of an NFT can be received by the data processing system 102 from a token exchange customer. The deposit received from customer can be maintained and protected by the data processing system 102.

All customer requests (i.e., deposits, withdrawals, updates, issuance, exchange, protection) are received at the token transaction processor 250 of the data processing system 102. The token transaction processor 250 may communicate directly with client devices (e.g., client system 103) via a network (e.g., network 101). The token transaction processor 250 receives requests, token information (e.g., public key information, private key information, hash value, signature information, etc.), deposit information (e.g., metadata of tokens), account information, and the like from token exchange customer. Based on the received information, the token transaction processor 250 updates data in the ledger 161. The token transaction processor 250 communicates the other received information with the smart contract control structure 210, the cold storage processor 180, the blockchain storage 168, and the client system 103.

The blockchain storage 168 may process exchanges between the customers and the data processing system 102. As discussed above, in an example arrangement, the token transaction processor 250 secures the deposited NFT by transferring the NFT to a private key/public key pair owned by the data processing system 102. The blockchain storage 168 initiates these transactions. The exchange may take the form of a direct exchange from the customers wallet (e.g., public address associated with a wallet public key) to in internal address (e.g., hash of an internal public key) in the blockchain storage 168 of the data processing system 102. Accordingly, portions of metadata relating to the deposited NFT (e.g., the private key, the public key, the hash value, NFT value, any associated signatures or hashes, and so on) can be stored in the blockchain storage 168.

Still referring now to FIG. 8, the ledger 161 is a ledger or data storage that associates NFTs with NFT account numbers and customer identifications. The ledger 161 may be split into multiple ledgers. For example, as shown in FIG. 8, the ledger 161 includes a first listing of NFT accounts 192 (e.g., NFT deposit account, NFT savings accounts) and a second listing of NFT accounts 194 (e.g., NFT market accounts, NFT investment accounts, NFT lending, NFT retirement account). In some arrangements, the first listing of NFT accounts 192 may be accounts of the data processing system 102 and the second listing of NFT accounts 194 may be accounts of a different or remote data processing system (e.g., another financial instruction, another NFT exchange system, and so on).

As will be appreciated, the ledger 161 may further be organized according to various types of accounts and subaccounts. Each listing 192 and 194 includes a plurality of entries 196, each relating to a specific account within the data processing system 102. Each listing 196 can include an account number, a customer associated with the account number, and each listing may include one or more NFT identifiers (e.g., a number of NFT identifiers), and one or more DNFT exchange instrument identifiers (e.g., a number of DNFT exchange instrument identifiers), stored on the data processing system 102 of the customer. The customer may be identified by name, another identification (e.g., tax payer identification, social security number, and so on), or a combination thereof. The number of NFTs may express a positive number of NFTs (or portion of NFTs) associated with the NFT account (e.g., the number of NFTs deposited by the customer) or a number of NFTs (or portion of NFTs) owed to the bank (e.g., lent to the customer, used as collateral) (shown with a (−) indicator attached to the NFT identifier in the NFTs column). Additionally, in some arrangements, customers may share NFTs (e.g., 55552) such that each of the NFT accounts may have a record of the NFT. Shared NFTs may be a multi-sig NFT or a single-sig NFT that can be exchanged by any of the NFT accounts. For example, NFT accounts 194 depict two accounts that share the “99992(−)” NFT, where the NFT may be a digital asset such as a loan and the two accounts may be two people that are married or in a relationship. In another example, NFT accounts 192 depict two accounts that share the “55552” NFT, where the NFT may be a digital asset such as a piece of artwork and the two accounts may be people that purchased the artwork together.

The NFT account holders may have access to the NFT metadata included in the ledger 161 (e.g., via a website associated with the data processing system 102, an application running on a smartphone or tablet, in-person at a location of the data processing system 102, and/or through an ATM associated with the data processing system 102). Although the ledger 161 associates NFTs with individual accounts, the ledger 161 does not associate specific private keys, public keys, and hashes with specific NFT accounts. The number of NFTs listed in the ledger 161 is decoupled from the address storing the NFTs deposited and the value of each NFT within the blockchain storage 168. As indicated in FIG. 8, the number of entries listed in the ledger 161 may be much less or much greater than the total amount of addresses (or blocks) storing NFTs on deposit in the blockchain storage 168. For example, the number of entries in the ledger 161 may be for 20 NFT accounts, whereas there may be one block for storing all the NFTs of the plurality of NFT accounts (e.g., the number of entries in the ledger 161 would be greater than the number of blocks storing the NFTs of the NFT accounts). In another example, the number of entries in the ledger 161 may be for 20 NFT accounts, whereas there may be one block for each NFT of the 20 NFT accounts (e.g., the number of entries in the ledger 161 would be less than the number of blocks storing the NFTs of the NFT accounts). As shown, the blockchain storage 168 can also include a permission blockchain 260 with blocks 262 linked with one or more of the metadata objects 224, the restricted tokens 220, or the smart contract control structures 210.

The blockchain storage 168 includes the key dataset 169 that stores the private keys, public keys, hash values, and values of tokens associated with each private key/public key/hash value group. When the token transaction processor 250 receives an NFT from a customer, the information relating to the received NFT (i.e., the private key, the public key, the hash value, an indication of the value of NFT, metadata, control structure, smart contract) can be stored in the blockchain storage 168 including in the key dataset 169. When the token transaction processor 250 provides an NFT to a customer in a withdrawal, the NFT is ultimately transferred based on the control structure and/or smart contract stored in the blockchain storage 168. After the withdrawal is complete, the ledger 161 is updated to reflect the appropriate changes in ownership of one or more NFTs.

As shown, the blocks 262 of the blockchain storage 168 can include various information such as an address (e.g., public address), a previous address (e.g., pointer to the previous block on the blockchain), a header/data (e.g., including pointers to off-chain metadata of the NFT, metadata of the NFT, smart contract execution code), control structure identifier (e.g., pointer to the control structure restricting the output of the NFT), and/or cold storage pointers (e.g., pointer to a public address on the cold storage ledger 182). Furthermore, as shown, the key dataset 169 can include a plurality of public-private key pairs (PuK-PrK) or individual public keys (PuK), where an “I” leading the PuK or PrK indicates an internal key, “W” leading the PuK or PrK indicates a wallet key, and “C” leading the PuK indicates a cold storage key.

Information contained in the ledger 161 and the blockchain storage 168 are routinely reconciled by the data processing system 102. The reconciliation of the information contained in the ledger 161 and the blockchain storage 168 (as well as other assets of the data processing system 102) that the information contained within the ledger 161 is up-to-date and accurate. The information is reconciled to ensure that the number of assets (e.g., tokens) on hand is accurate, the number and balance of loans outstanding is accurate, and the value of NFTs associated with individual NFT accounts is accurate. The reconciliation processes may be carried out by the token transaction processor 250. The reconciliation process may be performed on a repeating basis (e.g., on a daily basis, on an hourly basis, etc.). The token reconciliation process may be performed in conjunction with any reconciliation of other assets of the data processing system 102.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed:

1. A system comprising a data processing system, the data processing system comprising a memory and one or more processors configured to:
receive, from a first computing system, a commitment request corresponding to first funds;
in response to receiving the commitment request, generate first tokens by tokenizing the first funds;
transmit the first tokens into a first digital wallet;
generate share tokens based on a number of shares corresponding to the first funds;
transmit the share tokens to a second digital wallet associated with the first computing system;
determine return based on a quantity of the share tokens;
convert, based on the return, second tokens to second funds, comprising:
burn the second tokens by transmitting the second tokens to an un-spendable address, and
retrieve the second funds from a return funds account; and
transmit the second funds to a first funds account.

2. The system of claim 1, wherein the one or more processors further configured to:
receive a servicing request corresponding to a loan;
in response to receiving the servicing request, generate a loan token by tokenizing the loan, the loan token corresponding to a payment schedule; and
transmit the loan token to the first digital wallet.

3. The system of claim 2, wherein the one or more processors further configured to:
receive a loan update request corresponding to third funds and an updated payment schedule;
generate third tokens by tokenizing the third funds;
transmit the third tokens to the first digital wallet; and
modify the loan token to include the updated payment schedule.

4. The system of claim 3, wherein modifying the loan token comprises:
burning the loan token;
generating a new loan token corresponding to the payment schedule and the updated payment schedule; and
transmitting the new loan token to the first digital wallet.

5. The system of claim 1, wherein tokenizing the first funds comprises:
generate a funds metadata object comprising metadata of the first funds; and
generate, based on the funds metadata object, the first tokens each comprising a link to the funds metadata object.

6. A system comprising a data processing system, the data processing system comprising memory and one or more processors configured to:
receive, from a first computing system, a commitment request corresponding to first funds and an agreement;
in response to receiving the commitment request, generate first tokens by tokenizing the first funds and generate an agreement token by tokenizing the agreement;
transmit the first tokens to a first digital wallet; and
transmit the agreement token to a second digital wallet associated with the first computing system.

7. The system of claim 6, wherein the one or more processors are further configured to, in response to receiving a conversion request associated with the first tokens, convert the first tokens into fiat funds and transfer the fiat funds into a funds account associated with the one or more processors.

8. The system of claim 6, wherein:
tokenizing the first funds comprises:
generate a funds metadata object comprising metadata of the first funds, and
generate, based on the funds metadata object, the first tokens comprising a link to the funds metadata object; and
tokenizing the agreement comprises:
generate an agreement metadata object comprising metadata of the agreement, and
generate, based on the agreement metadata object, the agreement token comprising a link to the agreement metadata object.

9. The system of claim 6, wherein the one or more processors are further configured to:
receive a loan tokenization request corresponding to a loan;
in response to receiving the loan tokenization request, generate a loan token by tokenizing the loan; and
transfer the loan token to the first digital wallet.

10. The system of claim 9, wherein the one or more processors are further configured to:
generate, based on servicing tape loan data associated with the loan, a data report comprising loan yield; and
tokenize the servicing tape loan data.

11. The system of claim 10, wherein the one or more processors are further configured to:
receive second funds based on the loan yield;
generate second tokens by tokenizing the second funds; and
transfer the second tokens to the second digital wallet.

12. The system of claim 11, wherein the one or more processors are further configured to, in response to receiving a conversion request associated with the second tokens, convert the second tokens into fiat funds and transfer the fiat funds into a first funds account.

13. The system of claim 11, wherein the one or more processors are further configured to:
receive a payment indication associated with third funds;
in response to receiving the payment indication, generate third tokens by tokenizing the third funds;
transfer the third tokens to the first digital wallet;
determine, based on the servicing tape loan data and the third funds, whether the loan is paid off; and
in response to determining that the loan is paid off, burn the loan token.

14. The system of claim 13, wherein burning the loan token comprises transmitting the loan token to an un-spendable address of a digital wallet.

15. The system of claim 13, wherein the one or more processors are further configured to, in response to receiving a conversion request associated with the third tokens, convert the third tokens into fiat funds and transfer the fiat funds into a funds account associated with the one or more processors.

16. A system comprising a data processing system, the data processing system comprising memory and one or more processors configured to:
receive a commitment request corresponding to an agreement;
in response to receiving the commitment request, generate an agreement metadata object comprising metadata of the agreement and one or more transferring attributes for transferring first funds associated with the agreement from a user funds account to an entity funds account;
generate, based on the agreement metadata object, an agreement token comprising a link to the agreement metadata object and encapsulated within a control structure that restricts transfer of the first funds from the user funds account into the entity funds account;
continuously monitor the agreement based on collecting off-chain data from one or more off-chain data feeds;
detect, by the control structure, at least one transferring attribute of the one or more transferring attributes is satisfied based on the off-chain data;
in response to detecting the at least one transferring attribute is satisfied, transfer the first funds from the user funds account into the entity funds account;
in response to transferring the first funds, generate first tokens by tokenizing the first funds; and
transmit the first tokens into a first digital wallet.

17. The system of claim 16, wherein tokenizing the first funds comprises:
generate a funds metadata object comprising metadata of the first funds; and
generate, based on the funds metadata object, the first tokens each comprising a link to the funds metadata object.

18. The system of claim 16, wherein the one or more processors are further configured to, in response to receiving a conversion request associated with the first tokens, convert the first tokens into fiat funds and transfer the fiat funds into a funds account associated with the one or more processors.

19. The system of claim 16, wherein the at least one transferring attribute comprises a requested funds amount requested from the entity funds account being larger than an amount of funds available in the entity funds account.

20. The system of claim 16, wherein the metadata object of the agreement comprises at least one of a text document associated with the agreement, a digital image associated with the agreement, or a video associated with the agreement.
